(19) United States
(12) Patent Application Publication
(10) Pub. No.: US 2006/0168147 A1
(43) Pub. Date: Jul. 27, 2006

(54) Information processor, file server, accounting control system, accounting control method, and recording medium recording a program therefor

(75) Inventors: Taro Inoue, Tokyo (JP); Yoshiki Ooka, Tokyo (JP); Takenao Sata, Tokyo (JP); Tooru Shida, Tokyo (JP); Naoyuki Hada, Tokyo (JP); Makoto Asahina, Tokyo (JP); Shun-ichi Yamauchi, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Kabushiki Kaisha Sega

(21) Appl. No.: 11/356,074

(22) Filed: Feb. 17, 2006

Related U.S. Application Data
(62) Division of application No. 09/717,226, filed on Nov. 22, 2000.

(30) Foreign Application Priority Data
Nov. 24, 1999 (JP) 11-333467
Jan. 5, 2000 (JP) 2000-5298
Apr. 14, 2000 (JP) 2000-114452
Nov. 21, 2000 (JP) 2000-354166

(51) Int. Cl. G06F 15/16

(52) U.S. Cl. 709/219

(57) ABSTRACT

The object of the present invention is to manage the use number relating to a user in a suitable manner, when a game device operated by a user downloads a file, such as a game program, or the like, from a file server, in order to play a game. Therefore, the present invention is a charge management server which stores use number data relating to a use number for a user, and a group of files for supply to the aforementioned user, performs authorization to permit or refuse connection on the basis of individual information relating to the user as transmitted by the game device operated by the user, receives a file transmission request sent by a game device having undergone the aforementioned authorization process, transmits a particular file as specified by the aforementioned file transmission request to the aforementioned game device, receives a confirmation message sent by said game device having completed reception of the aforementioned particular file, and updates the use number data of the aforementioned user.

### BACKGROUND OF THE INVENTION

### Field of the Invention

The present invention relates to a use number management system constituted by a client server. More particularly, the present invention relates to technology for implementing charging relating to the number of use operations made by a client and to streaming data, when an information processing device (or network terminal device) located at a client device downloads files of game program applications, or program data, such as audio and video software, and the like, from a file server (or contents server).

In general, when a user seeks to connect to the Internet, he or she does this by means of a company (service provider) which provides an Internet connection service. In this case, the service provider collects a use fee from the user for the connection service, by means of a time-specific charge system or a fixed-time charge system. A time-specific charge system is a system where a use fee is charged according to the period of time during which the user is connected to the network, whilst with a fixed-time charge system, a fixed charge is levied for a predetermined amount of time, regardless of the period of time for which the user is connected.

A known charge system relating to the aforementioned time-specific charge system is a system where, for example, a use number (number of connections) indicating a previously determined potential use time corresponding to individual user information is stored in a network server, a use fee is calculated according to the user connection time and the number of connections is reduced according to the result of this calculation, and an Internet connection service can be provided as long as the number of connections has not reached zero (Japanese Patent No. 2939723).

Moreover, conventionally, a method such as that described below is known in order to enable contents stored in a file server, such as an FTP server, or the like, to be distributed. In other words, a method is known whereby an authentication key must be obtained in order to implement a game program downloaded from a file server, and this authentication key is notified to a user wishing to implement the program application by means of a prescribed method, whereby payment is made into an real specified bank account, or payment is made by means of virtual currency (electronic currency), or the like.

Moreover, one type of service using the Internet which has received attention is content distribution, for example, Internet broadcasting (TV, radio). The ‘content’ comprises digitised information, such as video images, still images, sound, text, numerical values, and the like, as commonly used by various media involved in digital computer technology. Of the foregoing, video images, sound, and the like are time series data, which may be supplied from a home page, as a channel program, or the like, but in this case, the volume of data is very large. Therefore, since a video program is downloaded from the contents server (for example, a video/audio server) and stored in its entirety in the user's personal computer before it is played back, a long period of time is required until the start of playback. Furthermore, contents storage means, such as a high-capacity hard disk, or the like, are required. Therefore, in the case of video or sound program contents, a streaming distribution method is implemented using the Internet or a communications (or broadcast) satellite as a transmission medium. On the reception side, received content data is progressively reproduced (streaming playback) by means of a streaming playback program, whereby it can be enjoyed in the same manner as a television broadcast or sound broadcast (radio).

However, if the user is employing a network service, then the time required for downloading the content file and reading information will principally be governed simply by the size of the content (file size), and the level of congestion of the communications network, regardless of the value of the content, or the like. Therefore, in the aforementioned time-specific charging system, the user is obliged to connect for a long period of time, simply because the content size is very large, or due to network congestion which is not the responsibility of the user, and hence the use charge increments compulsorily during this period. This also presents problems in that the fee increases at times of congestion, even when downloading the same contents.

Moreover, if Internet-based game contents are supplied, for example, then depending on the subject of the game, the amount of time required for playing the game once, and hence the associated charge, become very large indeed, and bearing this consideration in mind, it has not been possible for users readily to enjoy such games.

Moreover, in a so-called network competition type game where a plurality of users compete with each other by means of a network, there is a possibility that an opponent's fee may expire during competition, and hence the game will be halted unilaterally. More specifically, in the aforementioned time-specific charging system, there is a problem in that the user continually suffers stress during the time that he or she is using a network service, with regard to the use fee which is continuously incrementing, and with regard to the possibility of sudden network disconnection due to expiry of the use fee.

On the other hand, the aforementioned fixed-time charging system has entailed problems in that although there is no stress with regard to continually incrementing charges during the period of use, the user is charged without regard to the frequency with which he or she actually uses the network service within the relevant time period, and hence this system does not provide accurate charging with regard to the value of the content received.

Moreover, if a plurality of users perform a plurality of download operations by sharing a single terminal, or the like, it is possible for a plurality of users to use a network service by means of the use fee relating to a single user, and consequently, the service provider will lose profit that it should essentially be collecting.

Moreover, a problem arises in that a fee is still charged with respect to periods where the service cannot be used for reasons beyond the user's responsibility, for example, due to server maintenance, or the like.

Furthermore, in a system where service provision is terminated at the moment that the number of connections becomes zero, there is a problem in that if processing requiring a certain amount of time, such as game download, or the like, has started whilst the remaining number of connections is low, and if the number of connections then becomes zero during the download operation, the service provision will be terminated compulsorily without the download operation being completed.

Furthermore, in an Internet system, it has not been possible for information on the remaining number of connections held in the server to be displayed, continuously and in a real-time fashion, on the screen, or the like, of the terminal device being used by the user. Therefore, the user is required to confirm and remember the remaining use number available by means of a remaining use number confirmation screen, or the like, separately provided on the network server, but with the passage of time, this information tends to become imprecise. Therefore, a problem arises in that a time difference occurs between the actually available use time and the available use time as perceived by the user.

Furthermore, with any of the foregoing charge methods, there is a problem in that a fee is charged regardless of whether or not download of the content is completed properly, due to a communications fault, or the like.

Moreover, in the aforementioned fixed-time charge system, there is a problem in that however high the frequency with which the user uses the service, the party creating and providing the service cannot expect to receive profits above a particular level.

Furthermore, in conventional network games, it has been sought to realize a system capable of collecting a fee each time a game is played, similarly to a so-called arcade game. For example, currently, once software has been downloaded onto a storage medium by paying a charge, it is not possible to levy a further charge, regardless of the subsequent frequency of use of the software by the user. In other words, no matter how high the frequency of use for one user, no further profit can be obtained beyond the initial selling price, and hence if the number of people using the software is low, then it will not be possible to raise profits further. Consequently, no matter how low the frequency of use for one user, a profit base price is not applied, and it is necessary to allocate a corresponding capacity on the server to store the software for a period of time until a certain degree of profit can be obtained.

In a situation of this kind, providers tend towards creating products targeted at a small number of ‘game-mania’ or experimental products for which they are more or less resigned to not achieving a profit, and consequently, there has a been a risk that this will lead to inflation of prices and standardization and stagnation of the market.

On the other hand, in cases where authentication keys are distributed upon payment of a fee, the following kinds of problems have occurred, due to the fact that the content itself is supplied in the form of off-line package media. Specifically, this incurs manufacturing and distribution costs, and increased division of profits, and leads to serious inflation of the software price. Moreover, in cases where package media are distributed containing non-rewriteable contents, as a measure to combat copying, it is difficult to implement detailed solutions for debugging, and the like. Furthermore, in charging methods of this kind, charge processing is performed at the server side simultaneously with displaying the intentions of the user, such as start download, or the like, and hence a fee is charged even in cases where download is not performed correctly due to a communications fault, or the like.

The charging methods described above are implemented with respect to the download of a game program application, but for the user actually executing the game, the purpose of the game is only achieved as and when he or she plays the desired game. Furthermore, a user who has played a game a large number of times will lose interest in the game, and therefore it is not necessary for him or her to store a downloaded game program application indefinitely.

Moreover, as described above, the contents provider, such as a web television provider, or the like, charges by a payment-on-demand method for supplying respective video programs, or the like, and is able to receive use income from a web page, but if a circuit disconnection occurs due to a communications error, maintenance, or the like, during transmission of a program, then no fee is charged since provision of the program has not been completed. Furthermore, if the viewer halts reception of the program during transmission, then no fee is charged. If charging is performed on a long-term contract, such as a monthly or annual contract, then a relatively high fee will be charged to a user who wishes to view only a particular program.

### SUMMARY OF THE INVENTION

Therefore, the object of the present invention is to manage charging for game programs and execution of such game programs, by managing use numbers for a user, in cases where an information processing device operated by a user downloads a file, such as a game program, or the like, from a file server, in order to play a game.

More specifically, the first object of the present invention is to enable the use number for a user to be managed in an appropriate manner, even in cases when an error has occurred through no fault of the user.

Furthermore, the second object of the present invention is to manage charging for a game program or implementation of a game, in such a manner that a game program downloaded from a file server can be executed within a predetermined use time period.

Moreover, the third object of the present invention is to manage charging for a game program or implementation of a game, in such a manner that a program application can be downloaded from a file server within a predetermined use time period.

Furthermore, the fourth object of the present invention is to enable a game to continue to be played within a prescribed time period, if the predetermined use time period has expired.

Moreover, the fifth object of the present invention is to provide a charging method whereby the user of a content supply server is charged in accordance with the amount he or she uses.

Furthermore, the sixth object of the present invention is to provide a charging device for charging a user for a content supply service which delivers digital video images, and the like, in real time, in accordance with the amount used.

In order to achieve the aforementioned objects, the invention is specified as follows.

Namely, the file server according to the present invention comprises: first storage means for storing use number data relating to the number of uses by a user; second storage means for storing a plurality of files for provision to the user; authorizing means for performing authorization to permit or refuse connection on the basis of individual information for the user transmitted by an information processing device operated by the user; responding means for receiving a file transmission request sent by an information processing device having undergone the authorization, reading out a particular file as specified by the file transmission request from the second storing means, and transmitting same to the information processing device; and updating means for receiving a confirmation message sent by the information processing device having completed reception of the particular file, and updating the use number data for the user as stored in the first storing means.

Here, the updating means comprises confirming means for receiving a confirmation message sent from the information processing device having completed reception of the particular file, and judging whether or not transmission of the particular file has been successful; and updating means for updating the use number data for the user as stored in the first storing means when it is judged that transmission of the particular file has been successful.

Furthermore, the responding means sends data relating to the file size of the particular file to the information processing device.

Moreover, the confirming means receives the reception content received by the information processing device as transmitted back by the information processing device, and judges whether or not transmission of the file has been successful by comparing the particular file with the received reception content.

Furthermore, the responding means further sends the particular file as a plurality of partial files constituting the file.

Moreover, the updating means updates the use number data for the user in accordance with a use number value assigned respectively to each file stored in the second storing means.

The information processing device according to the present invention comprises: connecting means for sending individual information for a user to a file server, in order to connect to the file server; requesting means for sending a file transmission request relating to a particular file managed by the file server, to the file server; receiving means for receiving data relating to the particular file as transmitted from the file server in response to the file transmission request; judging means for judging whether or not reception of the particular file has been completed; and notifying means for sending a confirmation message to the file server in order to update the use number data relating to the use number for the user as managed by the file server, in cases where it is judged by the judging means that reception has been completed.

Here, the receiving means comprises means for receiving data relating to the file size transmitted from the file server; and the judging means judges whether or not reception has been completed on the basis of data relating to the file size and data relating to the received particular file.

The information processing device further comprises replying means for sending data relating to the particular file received by the receiving means, to the file server.

Moreover, the receiving means receives data relating to partial files constituting a particular file, and the replying means sends the received data relating to partial files to the file server.

The charge management system according to the present invention is a system constituted by the aforementioned information processing device and the aforementioned file server.

Moreover, the information processing device according to the present invention comprises: volatile storage means; receiving means for receiving a program application from a file server and outputting the received program application to the storage means; executing means for executing the program application; and halting means for halting the execution of the program application as executed by the executing means, on the basis of prescribed management information.

Furthermore, the information processing device according to the present invention comprises: volatile storage means; receiving means for receiving a program application from a file server and outputting the received program application to the storage means; executing means for executing an emulator program in order to run the program application; and halting means for halting the execution of the program application and/or the emulator program as executed by the executing means, on the basis of prescribed management information.

Desirably, the aforementioned prescribed management information is either information relating to the use time period of the program application or information relating to the number of uses thereof.

Desirably, the aforementioned information processing device erases the program application stored in the storing means, when the halting means has halted execution of the program application and/or the emulation program.

Desirably, the aforementioned information processing device further comprises means for receiving information relating to initial start-up from the file server; and the executing means executes the emulator program and/or the program application when the information relating to initial start-up is received.

Desirably, the aforementioned information processing device further comprises clock means for measuring time; the prescribed management information is information relating to the use time period of the program application; and the halting means halts execution of the program application and/or the emulator program on the basis of the time measured by the clock means and the use time period.

Desirably, the aforementioned receiving means receives management information relating to the use time period of the program application from the file server.

Furthermore, the information processing device according to the present invention comprises: volatile storage means; clock means for measuring time; first receiving means for receiving management information relating to a use time period from a file server; judging means for judging whether or not a program application transmission request can be made to the file server, on the basis of the time period measured by the clock means and the received management information relating to the use time period; second receiving means for making a transmission request for the program application to the file server, when it is judged that the transmission request can be made, receiving a program application sent from the file server in response to the transmission request, and outputting the received program application to the storage means; and executing means for executing an emulator program in order to execute the received program application.

Desirably, the information processing device further comprises halting means for controlling the executing means so as to halt execution of the program application and/or the emulator program, on the basis the time period measured by the clock means and a time period indicated by management information relating to the use time period.

Desirably, the halting means performs control in such a manner that execution of the program application and/or the emulator program is halted if the time period measured by the clock means has exceeded a time period obtained by adding a prescribed time period to the time period indicated by the management information relating to the use time period.

Desirably, the judging means judges that the transmission request cannot be made, in cases where the time period measured by the clock means exceeds the time period indicated by the management information relating to the use time period.

Desirably, the aforementioned emulator program is read in from an external storage medium, such as a floppy disk, CD-ROM, the Internet, or the like.

Moreover, the charge management server according to the present invention comprises: storage means for storing use number data relating to the use number of a user, wherein a second use number value is previously added to a first use number value that is to be reported to the user; authorizing means for performing authorization to permit or refuse a connection on the basis of individual information for the user transmitted from the client device operated by the user; updating means for updating the use number value indicated by the use number data, in accordance with the connection time of the user; and terminating means for terminating the connection with the client device, if the second use number value exceeds a prescribed value.

Furthermore, the charge management server according to the present invention comprises: storage means for storing use number data relating to the use number of a client device, wherein a second use number value is previously added to a first use number value that is to be reported to the client device; authorizing means for performing authorization to permit or refuse a connection on the basis of individual information for the client device transmitted from the client device; updating means for updating the use number value indicated by the use number data, in accordance with the connection time of the client device; and terminating means for terminating the connection with the client device, if the second use number value exceeds a first prescribed value.

Desirably, the authorizing means refuses a connection with the client device, if the first use number value indicated by the use number data exceeds a second prescribed value.

Desirably, the updating means updates the second use number value, if the first use number value exceeds the second prescribed value. In other words, the updating means updates the aforementioned first number value and when this has been used up, it updates the aforementioned second number value.

The charge management server according to the present invention comprises: storage means for storing use number data relating to the use number of a user; authorizing means for performing authorization to permit or refuse a connection on the basis of individual information for the user transmitted from the client device operated by the user; updating means for updating the use number value indicated by the use number data, in accordance with the connection time of the user; and terminating means for terminating the connection with the client device, if the use number value indicated by the use number data exceeds a prescribed value, and if it is judged that a prescribed date and time has passed.

Furthermore, the charge management server according to the present invention is a charge management server comprising: storage means for storing use number data relating to the use number of a user, which gives a prescribed use number value that is to be reported to the user; authorizing means for performing authorization to permit or refuse a connection on the basis of individual information for the user transmitted from the client device operated by the user; and updating means for updating the use number value indicated by the use number data, in accordance with the connection time of the user; wherein the portion of the number value updated by the updating means which exceeds the prescribed use number value is deducted from the use number data of the user, upon the next occasion that the user makes a connection.

Moreover, the charge management server according to the present invention comprises: storage means for storing use number data relating to the use number of a user, which gives a prescribed use number value that is to be reported to the user, authorizing means for performing authorization to permit or refuse a connection on the basis of individual information for the user transmitted from the client device operated by the user; and updating means for updating the use number value indicated by the use number data, in accordance with the connection time of the user; wherein the portion of the number value updated by the updating means which exceeds the prescribed use number value is deducted from the use number data of the user, upon the next occasion that the user makes a connection.

Desirably, the charge management server further comprises: receiving means for receiving a download request from the information processing device; and transmitting means for transmitting a particular file in accordance with the received download request; wherein, whilst the transmitting means is transmitting the particular file, the updating means updates the use number value indicated by the use number data according to a use number value corresponding to the file, instead of updating by a use number value corresponding to the connection time.

Desirably, the aforementioned charge management server updates the use number value indicated by the use number data, if the information processing device has completed reception of the particular file.

The content charging method according to the present invention for achieving the aforementioned objects is a content charging method for use when streaming video or streaming audio program data is delivered to a client device from a server by means of a communication network comprising the steps of: previously dividing the program data into a plurality of blocks and storing same; delivering one or a plurality of the divided block data, sequentially, from the server to the client device; receiving a reception notice sent from the client device to the server, each time the delivery is received; and implementing charging on the basis of the reception notice; whereby charging according to a specific (data-related) method can be implemented for provision of streaming data.

Furthermore, the contents server according to the present invention is a contents server for delivering program data to a client device by means of a communications network, comprising: storage means for storing the program data; delivering means for delivering the program data in response to a request from the client device; identifying means for identifying reception of a reception notice signal transmitted by the client device each time that a prescribed data volume of the program data is received; and charging means for implementing charge processing with respect to the client device, on the basis of the reception notice signal.

By means of this composition, the contents server is able to implement specific type charging for provision of streaming data.

Desirably, the program data is previously divided into blocks of a plurality of block data; the delivering means delivers one or a plurality of block data of the program data as a transmission unit; and the client device delivers a reception notice signal to the contents server each time that one or a plurality of block data is received.

Desirably, the program data includes streaming video or streaming audio data.

Desirably, the client device performs streaming reproduction of the received program data.

It is possible for the aforementioned client device to be constituted by a game device provided with communications functions.

Desirably, the program data is data to be reproduced in a continuous manner.

The client device according to the present invention is a client device in a network system whereby program data is delivered to a client device from a server by means of a communications network, comprising: delivery requesting means for requesting delivery of the program data from the server; receiving means for receiving the program data from the server; and notifying means for sending a reception notice signal to the server for each prescribed data volume of the program data from the server.

By means of this composition, the server is informed of the reception of data and hence charging can be implemented in accordance with the data volume actually received by the client device.

Desirably, the program data is previously divided into a plurality of block data; the receiving means receives the program data in units of one or a plurality of block data; and the notifying means sends a reception notice signal to the server each time one or a plurality of block data is received.

Desirably, in the aforementioned client device, the program data is data to be reproduced in a continuous manner.

Desirably, in the aforementioned client device, the program data includes streaming video or streaming audio data.

Desirably, the aforementioned client device further comprises reproducing means for performing streaming reproduction of the received program data.

Desirably, the client device is a game device.

The network content delivery system according to the present invention is a network content delivery system for delivering program data to a client device from a server by means of a communications network, in which the aforementioned server comprises: storage means for storing the program data; delivering means for delivering the program data in response to a request from the client device; receiving means for receiving a reception notice signal sent by the client device each time a prescribed data volume of the program data is received; identifying means for identifying the reception notice signal; and charging means for implementing charge processing with respect to the client device on the basis of the reception notice signal; and the aforementioned client device comprises: delivery requesting means for requesting delivery of the program data from the server; receiving means for receiving the program data from the server; and notifying means for delivering a reception notice signal to the server each time that a prescribed data volume of the program data is received from the server.

By means of this composition, the server is able to deliver contents to a client device by means of a network, at a charge which corresponding: to the actual amount of data received, rather than by charging by a monthly or yearly (time) contract, or by each content or each program unit.

Desirably, in the aforementioned network contents delivery system, the program data is previously divided into a plurality of block data; the delivering means delivers the program data in transmission units of one or a plurality of block data; and the client device transmits the reception notice signal to the server each time that it receives one or a plurality of block data.

Desirably, in the aforementioned network contents delivery system, the program data is data to be reproduced in a continuous manner.

Desirably, in the aforementioned network contents delivery system, the program data includes streaming video or streaming audio data.

Desirably, in the aforementioned network contents delivery system, the client device performs streaming reproduction of the received program data.

Desirably, in the aforementioned network contents delivery system, the client device is a game device.

Desirably, in the aforementioned contents charging method, a fee is determined for each block of the program data.

Furthermore, the present invention is a charge management system constituted by an information processing device and file server, wherein the file server comprises: first storage means for storing use number data relating to the number of uses by a user; second storage means for storing a plurality of files for provision to the user; authorizing means for performing authorization to permit or refuse connection on the basis of individual information for the user transmitted by an information processing device operated by the user; responding means for receiving a file transmission request sent by an information processing device having undergone the authorization, reading out a particular file as specified by the file transmission request from the second storing means, and transmitting same to the information processing device in a sequential fashion; confirming means for receiving a confirmation message sent from the information processing device having completed reception of the particular file, and judging whether or not transmission of the particular file has been successful; and updating means for updating the use number data for the user as stored in the first storing means when it is judged that transmission of the particular file has been successful; and the information processing device comprises: connecting means for sending individual information for a user to a file server, in order to establish a connection to the file server; requesting means for sending a file transmission request relating to a particular file managed by the file server, to the file server; receiving means for receiving data relating to the particular file as transmitted from the file server in response to the file transmission request; judging means for judging whether or not reception of the particular file has been completed; and notifying means for sending a confirmation message to the file server in order to update the use number data relating to the use number for the user as managed by the file server, in cases where it is judged by the judging means that reception has been completed.

Desirably, the program data is previously divided into a plurality of block data; the transmitting means transmits the program data in transmission units of one or a plurality of block data; and the information processing device transmits the reception notice signal to the file server each time that it receives one or a plurality of block data.

Furthermore, the storage medium according to the present invention stores a program application for causing a computer system to function as the aforementioned file server, information processing device, charge management server, content server, client device, charging system, or the like.

Moreover, the storage medium according to the present invention stores a program application for causing a computer system to perform the aforementioned charge management method, control method, or charging method.

Furthermore here, physical inventions can be understood as method inventions and method inventions can be understood as physical invention. Moreover, the aforementioned inventions can also be achieved in the form of a program product or storage means storing a program application for causing a computer to implement prescribed functions. Here, reference to a storage medium includes not only a hard disk (HD), DVD-RAM, flexible disk (FD), CB-ROM, or the like, but also a RAM or ROM memory, an on-line web page, or the like. Furthermore, reference to a computer also includes so-called microcomputers, and the like, whereby prescribed processing is implemented by means of a central processing device, known as a CPU or MPU, interpreting a program application.

Moreover, a client device is a device which receives services, such as provision of information, like various program application data, program data, or the like, from a server, and it comprises information processing devices, network devices, network terminal devices, PDA (portable information devices), portable telephone devices, and the like.

In this specification, reference to means does not simply indicate physical means, but also includes cases where the functions pertaining to that means are realized by software. Moreover, it is also possible for the functions pertaining to one means to be realized by two or more physical means, or for the functions of two or more means to be realized by one physical means.

### BRIEF DESCRIPTION OF THE DRAWINGS

Below, the present invention is described with respect to drawings referenced in order to aid understanding thereof.

FIG. 1 is a block diagram showing the composition of a game device relating to the present invention;

FIG. 2 is a block diagram showing the approximate composition of a charge management system relating to a first embodiment of the invention;

FIG. 3 is a sequence for describing an application example of a charge management system relating to a first embodiment of the invention;

FIG. 4 is a sequence for describing the details of file transmission processing;

FIG. 5 is a flowchart for describing the operation of a game device relating to a first embodiment;

FIG. 6 is a flowchart for describing the operation of a file server relating to a first embodiment;

FIG. 7 is a sequence for describing the details of file transmission processing relating to a second embodiment of the invention;

FIG. 8 is a flowchart for describing the operation of a game device relating to a second embodiment;

FIG. 9 is a flowchart for describing the operation of a file server relating to a second embodiment;

FIG. 10 is a block diagram showing the approximate functional composition of a game device relating to this embodiment;

FIG. 11 is a block diagram showing the functional composition of a device for implementing a game program realized by means of an emulation program;

FIG. 12 is a flowchart for describing the operation of a game device relating to a third embodiment of the invention;

FIG. 13 is a flowchart for describing the operation of a file server relating to a fourth embodiment of the invention;

FIG. 14 is a flowchart for describing the approximate operation of a charge management server relating to a fifth embodiment of the invention;

FIG. 15 is a flowchart for describing charge management processing in a network connection service relating to the fifth embodiment;

FIG. 16 is a flowchart for describing charge management processing in a network connection service relating to a sixth embodiment of the invention;

FIG. 17 is a flowchart for describing charge management processing in a network connection service relating to a seventh embodiment of the invention;

FIG. 18 is a sequence for describing charge management processing relating to an eighth embodiment of the invention;

FIG. 19 is a flowchart for describing relative value charge monitoring processing relating to the eighth embodiment;

FIG. 20 is a block diagram showing one example of a system composition to which the present invention is applied;

FIG. 21 is an illustrative diagram describing blocked streaming data;

FIG. 22 is a communications diagram describing communications between a terminal device and a contents server;

FIG. 23 is a flowchart describing the approximate operation of a terminal device;

FIG. 24 is a flowchart describing the approximate operation of a contents server; and

FIG. 25 is a communications diagram showing an example where reception is terminated at an intermediate stage.

### DESCRIPTION OF THE PREFERRED EMBODIMENTS

Below, embodiments of the present invention are described with reference to the drawings.

Firstly, an example is described of the hardware composition of an information processing device which can be used in the respective embodiments described below. The information processing device may employ a personal computer or game device provided with a network communications function.

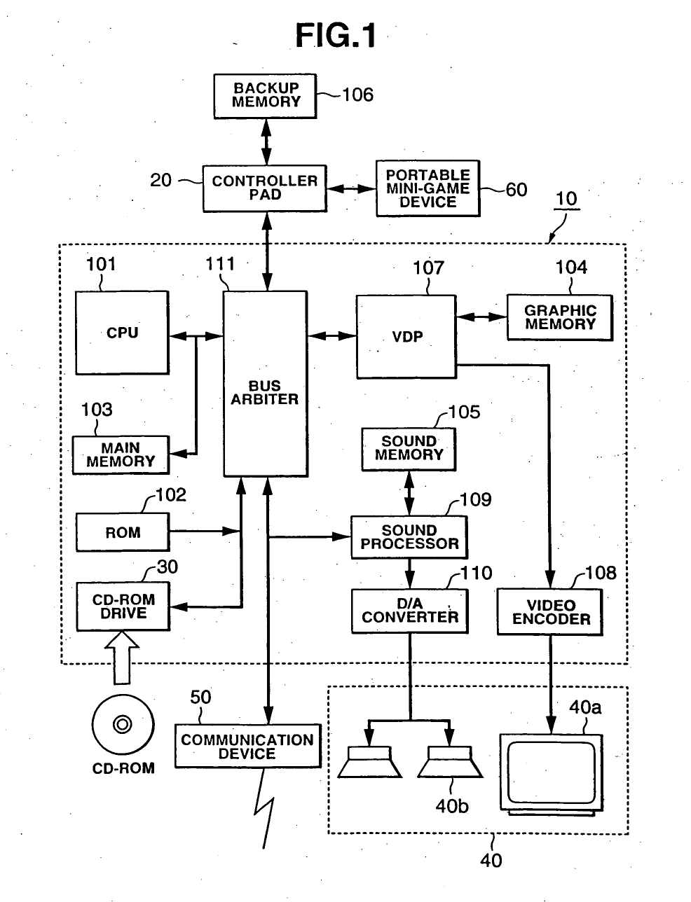

FIG. 1 is a block diagram showing the composition of an information processing device relating to the present invention. In FIG. 1, the information processing device relating to the present invention comprises a control section 10 constituted principally by a CPU 101, or the like, an input device (e.g. game controlling pad) 20 whereby a user inputs operating signals to said control section, an external storage device 30 for storing an operating system (hereinafter, called ‘OS’) and program applications (game programs), and inputting these programs to the aforementioned control section as and when necessary, and an output device 40 constituted by a display device 40a and speaker 40b, or the like, for supplying images and sounds to the user. Furthermore, a communications device 50 is provided for transmitting and receiving data to and from other computers and game devices, by means of a telephone circuit, or the like. The external storage device 30 is not limited to a CD-ROM, or the like, as illustrated, but may be any type of storage medium on which data from the control section 10 may be written and stored. Furthermore, a portable mini-game device 60 is provided, which is detachable with respect to the input device 20. This portable mini-game device 60 is provided with a control section, memory section, input section and output section for outputting sounds, images, and the like, in such a manner that a game can be played using this device alone. This portable mini-game device 60 functions as an external storage device for the main game device, and it also functions as a second information display device. The portable mini-game device 60 is also capable of performing various supplementary functions with respect to the main game device, and these functions are described hereinafter.

When the power supply is switched on in order to start a game, a boot program loader (not illustrated) loads a boot program (may also be called initial program) stored in the ROM 102 into the CPU 101, and the CPU 101 executes this boot program. In accordance with this boot program, the CPU 101 loads all of, or the required portions of, the OS stored in the CD-ROM, or the like, into the main memory 103, and executes the OS.

Under the control of the OS, the CPU 101 loads all of, or the required portions of, the program application (hereinafter, may also be called simply “program”) stored on the CD-ROM, or the like, into the main memory 103, and also loads drawing data and image data stored on the CD-ROM, or the like, into a graphics memory 104, as and when required. Sound data is also loaded into a sound memory 105.

Under the control of the OS, the CPU 101 executes the program application stored in the main memory 103. Data associated with execution of the program application is written to, and referenced from, the main memory 103 and a backup memory 106, as and when necessary. Data is stored in the back-up memory 106 in order to retain the previous state in the even of a power supply disconnection during a game, or the like.

In this embodiment, a composition is adopted wherein the OS, program application, or the like, are supplied from a CD-ROM, but it is also possible to use a composition wherein they are supplied from a ROM, or from another computer via a network.

A video display processor (VDP) 107 reads out drawing data required from displaying images, as stored in the graphics memory 104, and generates image data by executing various information processing (image processing) on the basis of commands and data from the CPU 101 according to execution of the program application. The various image processing includes, for example, texture mapping, light source processing, display priority processing, and the like. In order to display the generated image data on the display device 40a, the VDP 107 outputs this data to an encoder 108. It is also possible for the generated image data to be written to a frame buffer memory, for example, in such a manner that it is read out from this frame buffer memory at a prescribed timing.

The sound processor 109 reads out sound data stored in the sound memory 105 and implements various information processing (sound processing) on the basis of commands and data from the CPU 101 according to execution of the program application. The various sound processing includes, for example, effects processing, mixing, and the like. The sound data which has undergone this sound processing is then converted to analogue data by the D/A converter 110, and then output to a speaker.

A bus arbiter 111 provides control between the various units connected by means of a data transmission path (bus, or the like). For example, the bus arbiter 111 determines an order of priority for the respective units in order to decide which unit is to occupy the bus, and it allocates bus occupancy time for the occupying unit.

The information processing device relating to the present invention composed as described above performs prescribed functions by means of the CPU 101 executing programs read in from an external storage medium, such as a CD-ROM, or the like.

### First Embodiment

This embodiment is characterized in that charge processing is performed after a charge management system on the file server side has confirmed that a game device operated by a user has downloaded a file, such as a game program, from the file server.

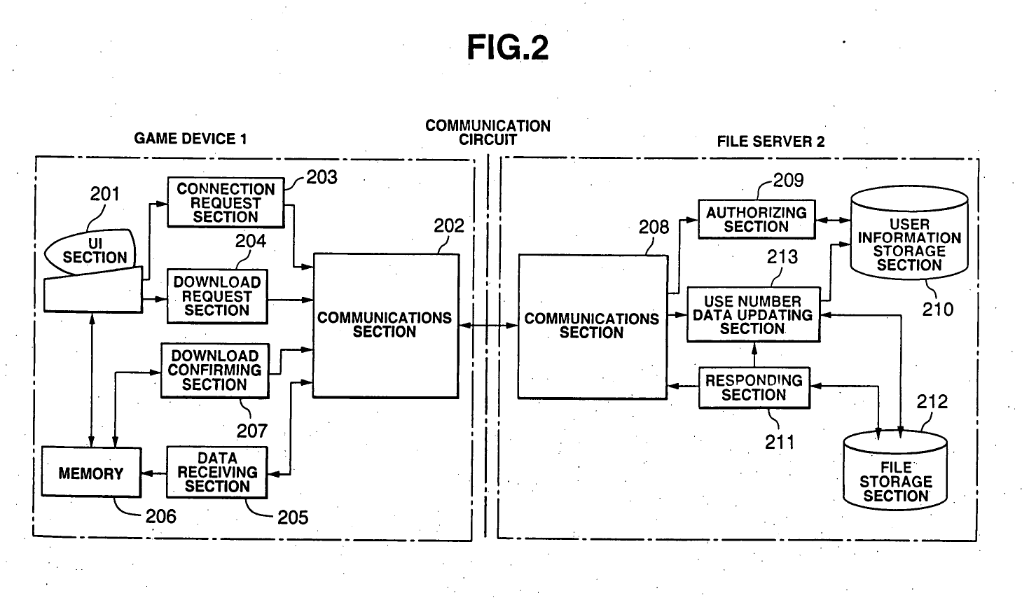

FIG. 2 is a block diagram showing the approximate composition of a charge management system relating to the present embodiment. As shown in the drawings, the game device 1 and file server 2 are connected by means of a communications network. Typically, the game device 1 is connected to the file server 2 by means of a dial-up connection using a telephone line, but the composition is not limited to this in particular, and it is also possible for the game device 1 to be connected to the file server 2 by means of a direct Internet connection. In the drawings, typical examples of a game device 1 and file server 2 are illustrated. The file server 2 has a plurality of connection channels, in such a manner that it can be connected to a plurality of game device simultaneously.

A user interface section (in the drawing, “UI section”) 201 is constituted by an input device 20 and output device 40 illustrated in FIG. 1, and by a driver for controlling same, and is used to perform interactive operations by the user. A communications section 202 is constituted by a communications device 50, such as a modem, and a driver for same, and it provides a communications service. A connection request section 203 makes connection requests to a designated file server 2 in accordance with connection requests supplied from the user interface section 201. When such a connection request is made, the connection request section 203 transmits individual information relating to the user, such as the user account and password, to the file server 2. Desirably, this individual user information is encrypted before transmission. The download request section 204 makes a file transfer request to the file server 2 in accordance with a download command supplied by the user interface section 201. The data (file) transmitted by the file server 2 in response to the file transfer request sent by the download request section 204 is received by a data receiving section 205 and is written to a memory 206 (corresponding to the main memory 103 in FIG. 1). The download confirmation section 207 judges whether the file requested by the download request section 204 has been downloaded (has been obtained) correctly, and it is judges that correct download has been achieved, then it transmits a confirmation message indicating termination of reception to the file server 2. If, for example, a game program has been downloaded to the memory 206, then upon receipt of a charge completion message from the file server 2, the program is executed by executing means (not illustrated).

Next, the functional composition of the file server 2 is described. In the present embodiment, the file server 2 is constituted as a single server device, but it is also possible to adopt a distributed system constituted by a charge management server for performing charge management, and a download data management server for performing file download.

The transmission section 208 has a plurality of connection channels and provides a communications service with the game device 1. The authorizing section 209 performs authorization to determine whether or not connection is permitted, in other words, whether or not log-in is permitted, with respect to a connection request transmitted by the game device 1 operated by the user. The authorizing section 209 judges whether to permit or refuse connection on the basis of the individual user information transmitted together with the connection request.

In other words, the authorizing section 209 judges whether or not the transmitted individual user information matches any of the user information items stored in a user information storage section 210, and if it determines that there is a match, then it permits connection with the game device 1 in question. The user information storage section 210 manages and stores user-related information for each individual user. The user-related information comprises the user account, passwords and number data relating to the available use number, and the like.

Upon receiving a file transfer request from the game device 1 for which connection has been permitted, a response section 211 reads out the file specified by the file transfer request, from a file storage section 212, and transmits same to the game device 1. The file storage section 212 manages and stores data, and the like, relating to various game programs, games, or the like, in a file format. The file size and the required use number value for download are assigned respectively to each of these files.

If there is a file transfer request, the response section 211 transmits the file size of the specified file to the game device 1, whereupon it transmits the file (main data). Upon receiving a confirmation message indicating completion of reception from the game device 1, a use number data updating section 213 obtains the use number value assigned to the transmitted file from the file storage section 212, and updates the use number value indicating the use number data for the user who requested the download. Typically, the use number value is represented by a positive number, and updating of the use number value is carried out by subtracting the use number value required for the download from the current use number value stored in the user information storage section 210.

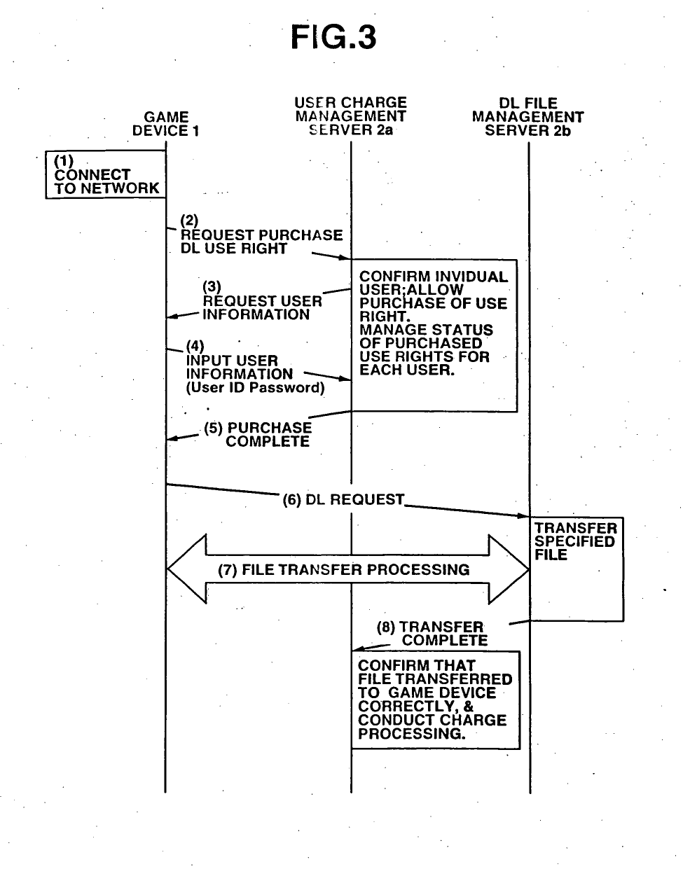

FIG. 3 is a sequence for describing an application example of a charge management system relating to the present embodiment.

Firstly, the user connects to the network by operating the game device 1 ((1) in the drawing), whereupon the user transmits a purchase request for acquiring a download right of use to the user charge management server 2a ((2)). In response to this purchase request, the user charge management server 2a transmits a user information request to the game device 1 ((3)). In response to this user information request, the user inputs a user account name (user ID), password and purchase number, and this information is transmitted to the user charge management server 2a ((4)). The user charge management server 2a carries out verification of the individual user on the basis of the transmitted user information, supplies a right of use (available use number) to the user, and transmits a notification that purchase has been completed to the game device 1 of the user ((5)). The user charge management server 2a manages the right of use status purchased by each respective user.

Next, the user having purchased a right of use operates the game device 1 to transmit a download request (file transfer request) to the download file management server 2b ((6)). The download file management server 2b reads out the file specified by the download request and performs transfer processing with the game device 1, in accordance with a prescribed file transfer procedure ((7)). When file transfer processing has completed, the download file management server 2b sends a notification indicating completion of transfer to the user charge management server 2a ((8)). Thereby, the user charge management server 2a recognizes that the file has been transferred correctly to the game device, and it performs charge processing, in other words, decrements the right of use, accordingly.

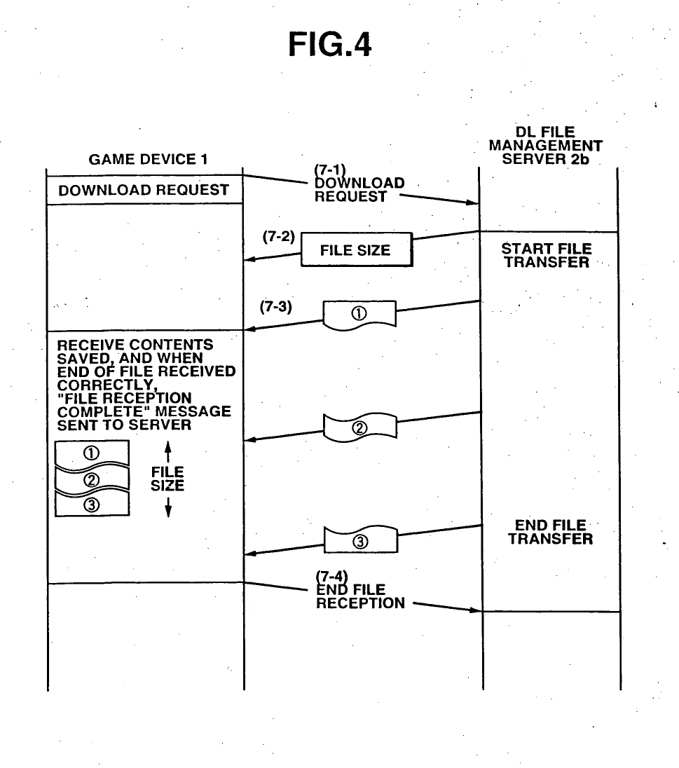

FIG. 4 is a sequence for describing the details of file transfer processing illustrated in FIG. 3. More specifically, when the game device 1 sends a download request to the download file management server 2b ((7-1) in the diagram), firstly, the download file management server 2b transmits the file size of the file to be transmitted to the game device 1 ((7-2)). Thereupon, the download file management server 2b transfers the actual file according to a prescribed transfer procedure ((7-3)). The game device 1 saves the received data in a memory. When the game device 1 has received the end of the file, the previously transmitted file size is compared with the received data size, and if it is judged that these sizes are matching, then it is regarded that reception has been completed correctly, and a confirmation message indicating completion of reception is transmitted to the download file management server 2b ((7-4)).

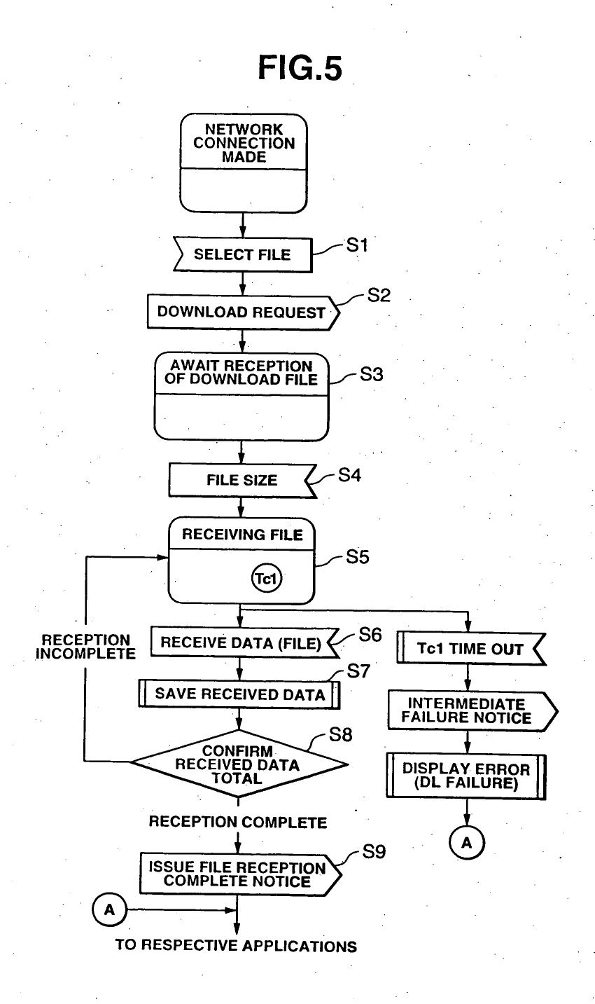

FIG. 5 is a flowchart for describing the operation of a game device 1 relating to the present embodiment. In the drawing, when a file is selected by the user (S1), the game device 1 connected to the network makes a download request to the file server 2 (S2), and enters a download file reception standby state (S3). Thereupon, the game device 1 receives the file size transmitted by the file server 2 (S4) and assumes a file reception state (S5). In the file reception state, a client timer (Tc1) monitors the data reception interval. The game device 1 receives data transmitted by the file server 2 (S6), and stores this received data in the memory (S7). The game device 1 checks the file size of the received data (S8), and if the previously received file size and the currently received file size are matching, then a confirmation message indicating the completion of file reception is conveyed to the file server 2 (S9), and processing is switched to the various applications.

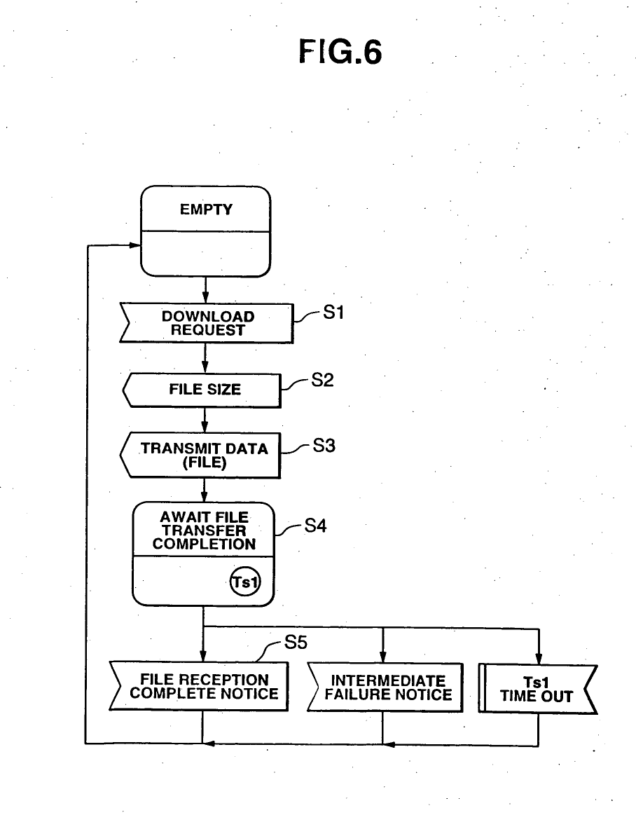

FIG. 6 is a flowchart for describing the operation of the file server 2 relating to the present embodiment. In this diagram, upon receiving a download request from the game device 1 (S1), the file server 2 sends a file size to the game device 1 (S2). Thereupon, the file server 2 transmits the specified file (S3) and assumes a file transfer completion standby state (S4). In this file transfer completion standby state, the server timer 1 (Ts1) monitors the time out until a file transfer completion notice is issued. Upon receiving a confirmation message indicating completion of file reception (S5), the file server 2 reverts to a standby state.

As described above, according to the present embodiment, when downloading a file from a file server, charge processing is performed after it has been confirmed that the game device of the user has received the file correctly, and therefore, it is possible to manage charging of the user in a suitable manner, even in cases where problems occur which are not due to the operations of the user.

Here, it is normal for a game supplier to increase continually the types of files offered on a server, in such a manner that it can supply a large variety of games to users. In many cases, the interest of the users is attracted by advance reporting the title of the game next to be supplied. However, since titles that are scheduled for download are also displayed in the form of advance information, rather than only displaying the titles of games that are already available for download, there may be cases where the file selected by the user is not present on the server. Consequently, in such cases, it is not possible to download the file, and hence means for supplying corresponding substitute information to the user is provided in the game device 1 and download file management server 2b.

In other words, the download file management server 2b retains actual file information indicating whether or not the actual file information is present, and when a download request is received from the game device 1, it verifies this actual file information. If the actual file information is “Yes”, then the download file management server 2b transmits the corresponding file to the game device 1. On the other hand, if the actual file information is “No”, then a notice indicating the absence of the actual file is transmitted to the game device 1.

After transmitting a download request to the download file management server 2b, the file is downloaded by the means described previously with regard to the first embodiment. On the other hand, if the game device 1 has received a notice indicating the absence of the actual file from the download file management server 2b, then substitute contents stored in the CD-ROM 30 are displayed on the display device 40a. Desirably, these substitute contents include, for example, preview images of the game in question, a trial type game which can only be used for a short period of time, a different game to the game in question, or the like.

Thereby, if the user has selected a game that is scheduled for download, then a preview version, or the like, is displayed as substitute contents, and hence it is possible to maintain the interest of users in the game, even if their expectations cannot be satisfied straight away. In this case, since no file download is performed, no notice indicating completion of transfer is conveyed to the user charge management server 2a and hence no charge processing is performed.

Cases where it is not possible for the user to download a file are not limited to cases where the file is not present in the server 2. Namely, there are also cases where the game device 1 cannot access the server 2, due to the fact that the server 2 is undergoing maintenance, or that the communications network is congested. In such cases, the actual file is present in the server 2, but the game device 1 is not able to download the file. Consequently, even in the case of a state where the user is not able to use the download service, the server 2 conveys a notice to this effect to the game device 1, and having received this notice, the game device 1 outputs a preview version of the game, or the like, as substitute contents.

Moreover, it is also possible to provide means whereby, in a case where the game device 1 is not able to download a file, the server 2 conveys a notice to this effect to the user, and the user is able to select whether or not to download substitute information. The server 2 downloads the prescribed substitute key to the game device 1 only in cases where the user wishes to download the substitute contents. On the basis of this substitute key, the game device 1 displays a data relating to a preview version or trial version, as stored on the CD-ROM. In this case, the substitute contents, such as the preview version, or the like, stored on the CD-ROM are only output when the user so desires. It may also be devised that, upon receiving a notice that a file cannot be downloaded from the server 2, the game device 1 simply reads out substitute contents from the CD-ROM and outputs same, without receiving a substitute key from the server.

Here, from the user requesting download of a file until download is completed, there may also be problems in the communications transfer circuit, causing download to take a long time. Since the user is obliged to remain in a standby state during the download period, the user may experience considerable stress before starting the game. Therefore, in order to prevent the user from being in a simple standby state, substitute video images and sound for the download period are previously stored in the CD-ROM 30, and means for supplying these substitute video images and sounds to the user during the download period are provided in the game device 1. Suitably, a description, preview, or the like, of the game in question can be supplied as the aforementioned substitute video images and sounds.

In other words, substitute video and sound information is previously stored in the CD-ROM 30. In combination with transmitting a download request, the game device 1 also sets a download request flag to ON and stores same in the memory 206. The game device 1 then reads out information relating to a game description, preview, or the like, which forms corresponding substitute video images and sounds, from the CD-ROM, and outputs same to the display device 40a. Thereupon, when file reception has been completed, a file reception complete flag is set to ON and this is similarly stored in the memory 206. If the download request flag and the file reception complete flag are both ON, then the game device 1 halts output processing of the preview information, or the like, resets both flags, and then reverts to an initial state. The game device 1 then displays a screen of the downloaded game.

By means of the foregoing, since a description or preview information, or the like, relating to the game in question is supplied to the user during the download period, the user is able to start the game in a smooth manner, without experiencing stress, and hence it is possible to provide a satisfactory game environment.

Moreover, since time is required for downloading, the user may switch the displayed to a television display, for example, rather than maintaining the download display screen. In situations of this kind, the user is not able to tell when download has been completed. Therefore, the user is obliged to estimate a certain period of time, himself or herself, and then return to the start screen of the game. Consequently, means are provided in the game device for indicating the download state, in order to reduce the burden on the user in such situations.

Here, suitably, the means for indicating the download state to the user is achieved by providing means for outputting the download state to the output screen of the portable mini-game device 60 provided on the controller pad 20, or means for outputting prescribed sounds by means of the speaker 40b.

When a download request is transmitted, the game device 1 receives the file size of the file to be transferred from the download file management server 2b. From this file size, the CPU 101 in the game device 1 calculates the predicted time required for download, and it monitors the download state. The game device 1 starts file download in accordance with the procedure described above with regard to the first embodiment. Thereupon, when the game device 1 sends a confirmation message indicating that file reception has been completed to the file server 2, a message indicating that download has been completed is output to the output screen of the portable mini-game device 60. Furthermore, a sound indicating the completion of download is output from the speaker 40b.

By calculating the predicted download time from the file size, the game device 1 is able not only to report the completion of download, but also to display a screen indicating the state of progress of the download, on the output screen of the portable mini-game device 60. In other words, the game device 1 calculates the predicted download time from the file size. It then initiates a measurement of the download time, whilst simultaneously initiating download. The game device 1 calculates the download status from the predicted download time and the measured time, and displays this status on the output screen of the portable mini-game device 60. It is also possible for a sound reporting the download status to be output from the speaker 40b. Furthermore, in the event of a download failure, it is possible to report that download has failed in a similar manner.

According to the foregoing, since the game device 1 is devised so as to report the status of download or completion of download to the user, it is possible to reduce the burden on the user involved in monitoring or predicting the download status him or herself. Moreover, the user can make effective use of the download time before starting the game.

### Second Embodiment

This embodiment is characterized in that, in order for a file server to recognize that a game device has received a file correctly, contents transmitted by the file server to the game device are compared with contents sent back to the file server by the game device as a reply, and if these contents are matching, then it is taken that the game device has received the file correctly and charge processing is implemented.

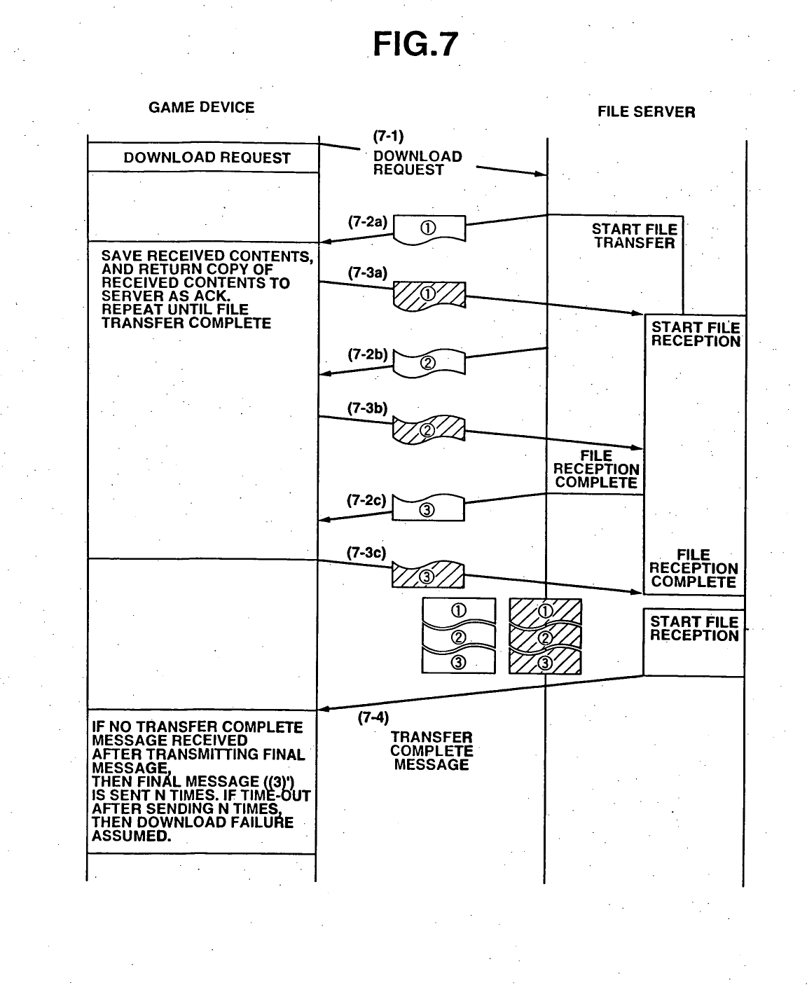

FIG. 7 is a sequence for describing the details of file transfer processing relating to this embodiment. The file transfer processing relating this embodiment corresponds to process (7) in FIG. 3 described with regard to the aforementioned embodiment.

Specifically, when the game device 1 transmits a download request to the download file management server 2b ((7-1) in the drawings), the download file management server 2b first transfers the main file to the game device 1 in accordance with a prescribed transfer procedure (7-2a). In this case, desirably, the main file is divided into several sections for transfer, rather than being transferred as a single item. The game device 1 stores the received contents in a memory, and also sends a copy of the received contents to the file server 2 as an ACK message (7-3a). Thereafter, until file transfer is completed, each time the game device 1 receives data from the file server 2, it sends back a copy thereof to the file server 2. The file server 2 compares the contents transmitted to the game device 1 with the received file contents, and if these contents are matching, it performs charge processing and also sends a transfer complete message to the game device (7-4). If the game device 1 does not receive a transfer complete message after the final content ((3) in the diagram) has been transmitted, then this final content is resent N number of times. In the event of a time-out after resending the data N times, it is judged that the download has failed.

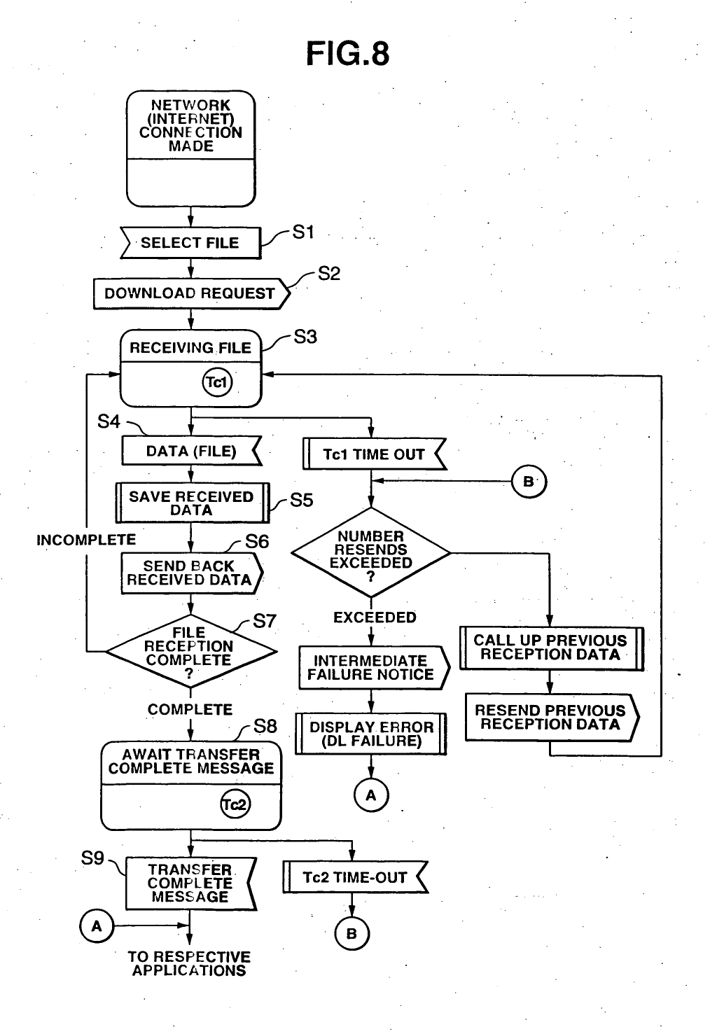

FIG. 8 is a flowchart from describing the operation of the game device 1 relating to this embodiment. In the diagram, when a file has been selected by the user (S1), the game device 1 connected to the network makes a download request to the file server 2 (S2), and then assumes a download file receiving mode (S3). Next, the game device 1 receives data transmitted by the file server 2 (S4), and stores the received data in the memory (S5). The game device 1 sends back a copy of the received data (S6), and determines whether or not file reception has been completed (S7). If it is judged that file reception has been completed, then the game device 1 assumes a standby state for receiving a transfer complete message (S8). In this transfer complete message reception standby state, a client timer 2 (Tc2) monitors a time-out until arrival of the transfer complete message. If a transfer complete message is received (S9), then the game device 1 switches processing to the respective applications.

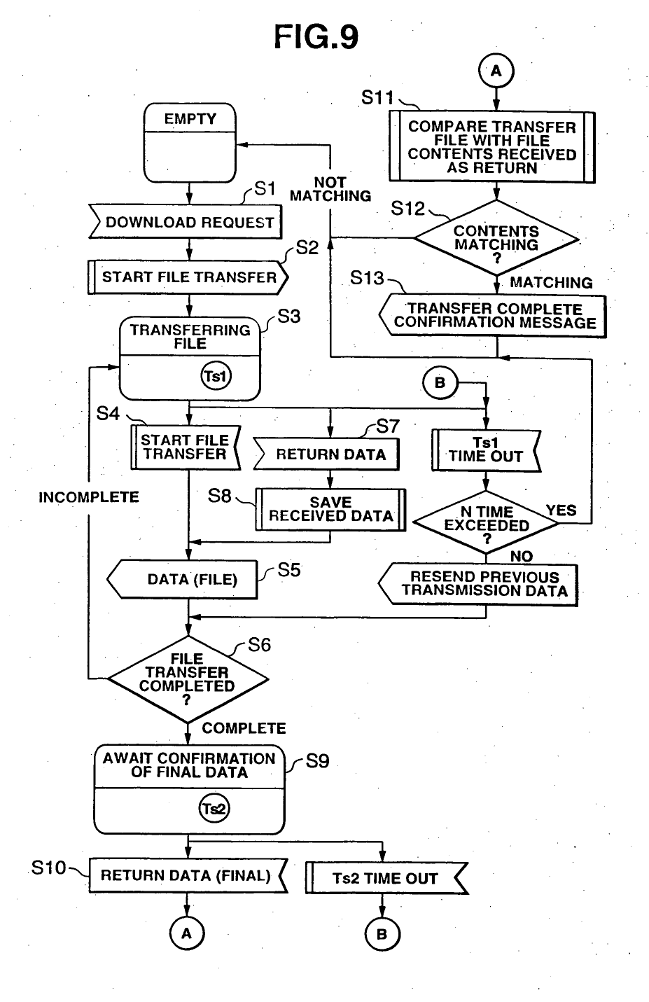

FIG. 9 is a flowchart for describing the operation of a file server 2 relating to the present embodiment. In this diagram, when a download request is received from the game device 1 (S1), the file server 2 calls up a file transfer module (S2), and assumes file transfer mode (S3). In file transfer mode, the file server 2 sends the specified file (S4, S5), and checks whether or not transfer of the file has been completed (S6). Moreover, upon receiving return data sent back by the game device 1 (S7), the file server 2 stores this data in a working buffer (S8). When transfer of the specified file has been fully completed, the file server 2 awaits reception of the final return data from the game device 1 (S9). In this state awaiting reception of the final return data, a server timer monitors a time-out until reception of the final data. When the file server 2 receives the final return data (S10), the transferred file and the return data are compared, and it is determined whether or not these contents are matching (S12). If it is determined that the contents are matching, the file server 2 sends a transfer complete message to the game device 1 (S13), and then reverts to the initial state.

In this manner, according to present embodiment, when downloading a file from a file server, charge processing is carried out after it has been confirmed that the game device of the user has received the file correctly, and therefore it is possible to manage charging of the user in an appropriate manner, even in cases where problems occur which are not due to the operations of the user.

Moreover, in the present embodiment, it is judged whether or not the download has been performed correctly by comparing the transferred file with return data sent back by the game device, and therefore a more accurate judgement can be made.

In cases where the download fails at an intermediate stage, it is necessary to download the file once again, but it is very inefficient if file transfer is always restarted from the beginning of the file. Therefore, means are provided whereby, in cases where a download failure occurs at an intermediate stage in either the game device 1 or file server 2, only the data following the download failure is retransmitted. In other words, either the game device 1 or the file server 2 is provided with means for judging the success or failure of download, and whenever a download request has been made, it determines whether or not the download has been successful. If the download has failed, then the portion of the file where download has been successful is taken as valid, and only the failed portion is retransmitted. In this case, optimally, the file server 2 previously divides up the file before transmitting same to the game device 1.

Means for restarting download from the portion of the file where a download failure occurred are described with reference to FIG. 7. As means for judging the success or failure of the download, the game device 1 changes the reception flag for the file in question from OFF to ON when the download has succeeded, and stores this in the memory.

Upon receiving the file divided into sections for transmission, the game device 1 sends a copy of the received contents to the file server 2, as an ACK, and stores the received information for the file in question in a memory. More specifically, it switches a first reception flag for the first file to ON. Thereafter, the game device 1 switches the reception flags corresponding to the received files (second reception flag, third reception flag, . . . ) to ON, and therefore, if a reception failure occurs, only the reception flag for the failed file will remain at OFF. Consequently, when download is restarted, the game device 1 first confirms the status of the reception flags and sends a download request to the file server 2 for the file having a reception flag set to OFF, whereupon the file server 2 continues download from the file relating to this request. Furthermore, when the game device 1 has received a transfer complete message, it resets all of the reception flags (to OFF), thereby restoring an initial state. In this way, it is possible to shorten the download time, and hence file download can be performed in an efficient manner.

### Third Embodiment

This embodiment is characterized in that a file (game program) downloaded from a file server is stored in a volatile memory, an emulator program is initiated in order to execute the game program, and after a prescribed period of time has elapsed, execution of the program and/or emulator program is halted.

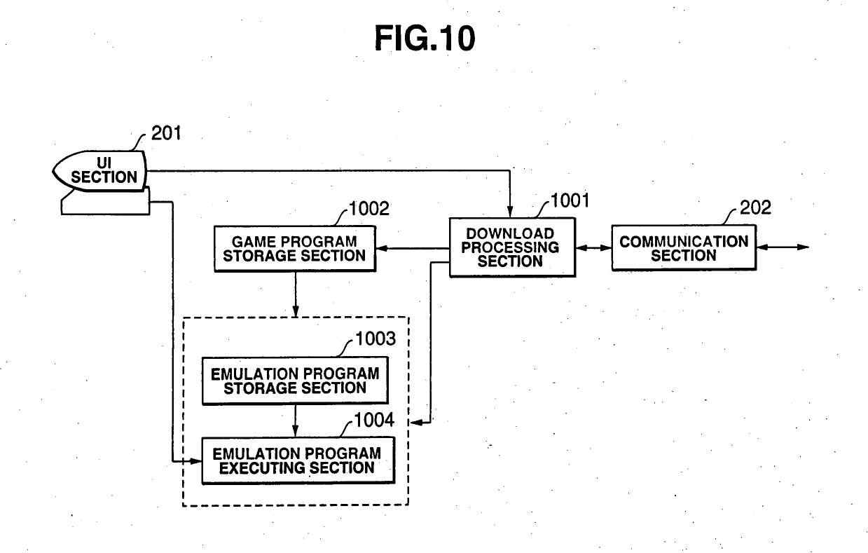

FIG. 10 is a block diagram showing the approximate functional composition of a game device relating to the present embodiment. In this diagram, the user interface section (shown as “UI section” in the diagram) 201 is constituted by the input device 20 and output device 40 as illustrated in FIG. 1, and drivers for controlling same, and is used to perform interactive operations by the user. The communications section 202 is constituted by a communications device 50, such as a modem, and a driver for same, whereby a communications service is provided. The download processing section 1001 downloads a specified file (game program) from a file server (not illustrated). Desirably, this download processing section 1001 is realized by means of the composition relating to the aforementioned embodiments. The download processing section 1001 writes the downloaded file to a game program storage section 1002. This game program storage section 1002 is provided in a volatile memory. An emulation program storage section 1003 stores an emulation program which is written from a CD-ROM, or the like, (not illustrated). Desirably, this emulation program storage section 1003 is also provided in a volatile memory. An emulation program executing section 1004 constitutes executing means for reading the emulation program and executing a game program.

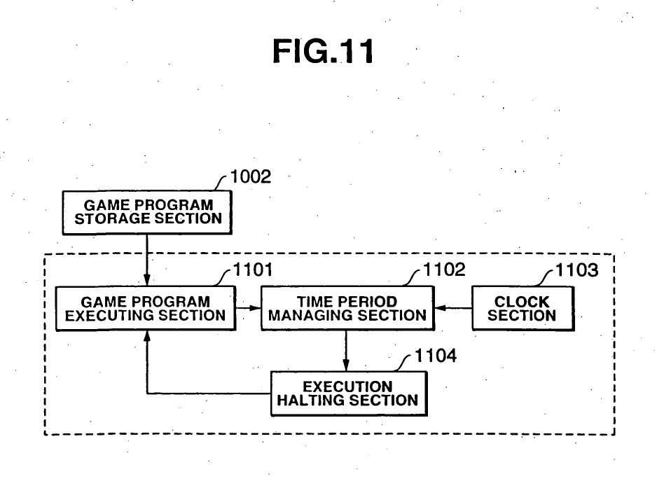

FIG. 11 is a block diagram showing the functional composition of the game program executing means realized by means of the emulation program. In this diagram, a game program executing section 1101 interprets and executes the game program. A time management section 1102 compares the available use time obtained by executing the game program with a time period measured by the time mechanism section 1103, and if the measured time period has exceeded the available use time, then it conveys a notice to this effect to an executing halt section 1104. Upon receiving notification that the usable time has been exceeded, the execution halt section 1104 performs control whereby the program execution of the game program executing section 1101 is halted.

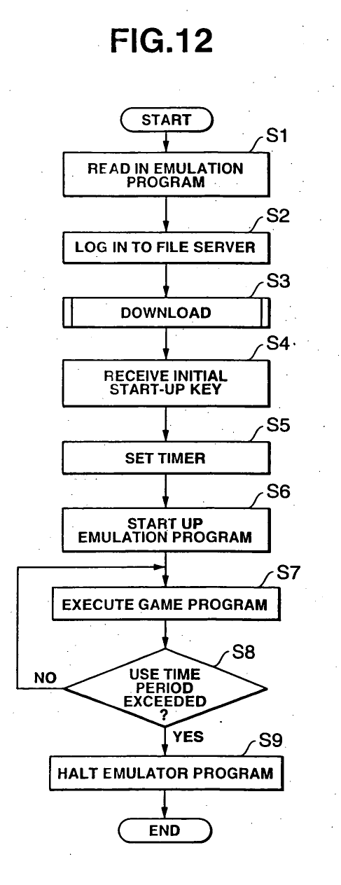

FIG. 12 is a flowchart for describing the operation of a game device relating to the present embodiment. In this diagram, when a CD-ROM is set in the CD-ROM drive of the game device 1, the game device 1 reads in an emulator program stored on the CD-ROM (S1), and logs in to the file server 2 by means of a connection program (S2). Thereupon, when a file (game program) has been selected by the user, the game device 1 carries out download of that file (S3). This file download can be performed by the procedure described in the various foregoing embodiments. When download is completed, the game device 1 receives an initial start-up key required to execute the downloaded game program, from the file server 2. Upon receiving this initial start-up key (S4), the game device 1 sets a timer (S5), and then starts up the emulator program using the initial start-up key (S6). Having executed the emulator program, the game device 1 executes the game program stored in the memory (S7). During execution of the game program, the game device 1 judges whether or not an available use time as given by the game program has elapsed (S8), and whilst the available use time has not elapsed, it continues to execute the game program. If, on the other hand, it judges that the use time has elapsed, then the game device 1 halts the emulator program (S9), and reverts to an initial state.

As described above, according to this embodiment, it is possible to execute a game program downloaded from a file server provided that the time remains within a previously set use time. Moreover, in the present embodiment, since the downloaded game program is stored in a volatile memory, then if the power supply to the game device is switched off, it is no longer possible to use that game program. Thereby, it is possible to introduce the concept of charging for a game program or for use of a game.

As one configuration of a file for downloading, it is possible to divide a single file, functionally, into a plurality of files. Desirably, it is divided into a main file which is principally associated with execution of the game, and subsidiary files for storing data, such as information defining the available use time for the game at the game device 1, operational condition parameters for the emulator program, and the like. In this case, with regard to increase in the volume of file data, the main file having a large data size is stored in the CD-ROM in the game device, whilst the subsidiary file having a small data size is stored in the server. Thereupon, it becomes possible to execute the game by downloading the subsidiary file from the server to the game device. In other words, after completing download of a header file, the game device 1 restores the header file and a ROM file to their original states in the memory 206 and it then executes the game.

In this way, since the file is divided into a subsidiary file of small data volume and a main file of large data volume, and only the subsidiary file is subject to downloading, it is possible greatly to shorten the time required for downloading. It is especially desirable to divide the file if it has a large data size, since the download time will be long and cause stress to the user.

Since the user cannot execute the game using only the main file stored on the CD-ROM, he or she must download the subsidiary file relating to that game if he or she wishes to play the game stored in the main file. Furthermore, in this case also, it is only possible to execute the game within the available use time period stored in the subsidiary file, and similarly to cases where the file is not divided, it becomes impossible to play the game program once the power supply has been switched off.

Moreover, the information stored in the subsidiary file is not limited to the game program use time or operational conditions parameters for the emulator program. For example, by storing information such as the number of available uses of the game, or the available use time limit, it is possible to set the game use conditions in a desired manner. The user is able to execute the game program as long as it remains within the available number of uses or the available use time limit as specified by the subsidiary file.

### Fourth Embodiment

This embodiment is such that a right to download a file (right of use) is purchased by a user, and the user is permitted to download from a file server within the validity period corresponding to that right of use.

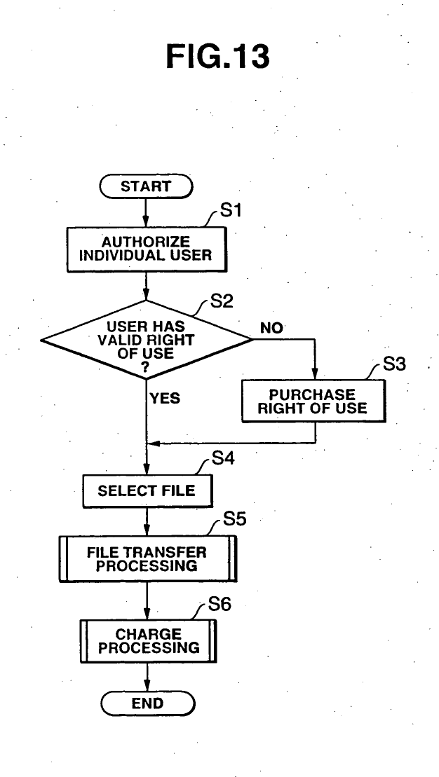

FIG. 13 is a flowchart for describing the operation of a file server relating to the present embodiment. As illustrated in the diagram, when there is a connection request from the game device 1, the file server 2 performs user authorization on the basis of transmitted individual user information, and then permits log-in (S1). The file server 2 judges whether or not the user is in possession of a valid right of use on the basis of the user information for the user logging in (S2). A valid right of use means that the use time limit applied to the right of use has not expired. The use time limit is, for example, specified as “until date XX/YY/ZZ”, or “for N number of days from date XX/YY/ZZ”. The file server 2 requires a user not having a valid right of use to purchase a right of use (S3). Next, a file to be downloaded from the game device 1 is selected by the user at the game device 1 (S4), and transfer processing for that file is implemented (S5). File transfer processing can be performed by a method according to one of the foregoing embodiments. If file transfer processing has been completed correctly, the file server 2 performs charge processing with respect to the right of use of the user (S6).

As described above, according to this embodiment, provided that the valid time limit specified for a purchased right of use has not expired, the user selects a file and is then able to download that file.

### Fifth Embodiment

This embodiment relates to a charge management server whereby a game device of a user receives network connection services in accordance with a use number which indicates usable time, characterized in that the use number is provided with a slight margin which is not notified to the user, whereby even if the use number as represented to the user has become zero, the network connection services are not terminated immediately.

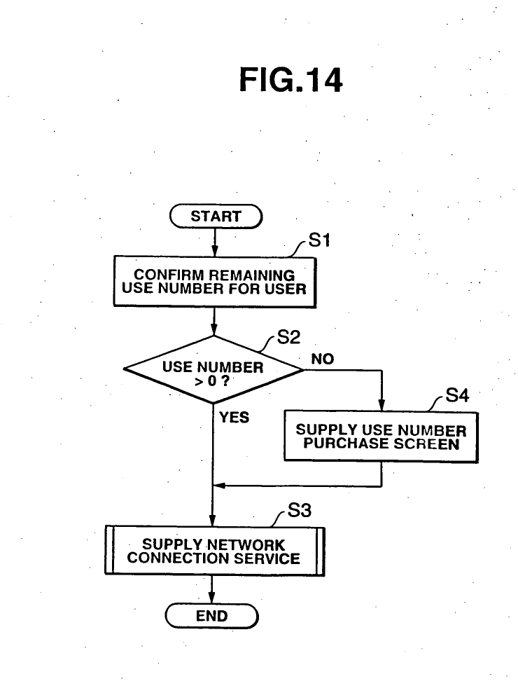

FIG. 14 is a flowchart for describing the approximate operation of a charge management server relating to the present embodiment. In this diagram, when a connection request is made by the game device 1, the charge management server performs user authorization on the basis of the transmitted user information, and also confirms the remaining use number for that user (S1). The use number indicates, for example, the available use time, in such a manner that each unit of 1 represents one minute. The charge management server judges whether or not the use number for the user is greater than zero (S2), and if it judges the use number to be greater than zero, then it provides a network connection service (S3). A network connection service means, for example, supplying a file download service, or supplying a network competition game service. On the other hand, if the use number is judged to be zero or less, the charge management server supplies a use number purchase screen to the game device 1 (S4), and if the user purchases a use number, then the network connection service is supplied, as described above.

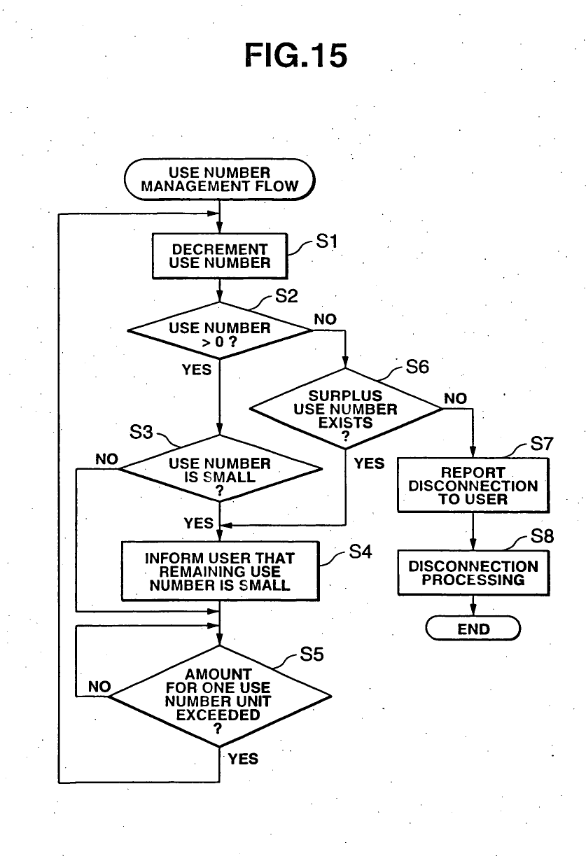

FIG. 15 is a flowchart for describing charge management processing in a network connection service relating to the present embodiment. In this diagram, when the user logs in to a server providing a network service, the use number for that user is reduced by 1 (S1). The charge management server judges whether or not the use number for the user is greater than zero (S2), and if it is judged to be greater than zero, then it is judged whether or not a small use number remains (S3). A small use number is set to mean, for example, that the use number is less than 10. If it is judged that a small use number remains, then the charge management server conveys a notice to this effect to the user (S4). The charge management server then judges whether or not the time period allocating to one use number unit has elapsed (S5), and if this time period is judged to have elapsed, then the sequence returns to S1 and the use number is decremented.

On the other hand, if at step 52, it is judged that the use number is zero or less, then the charge management server determines whether or not there exists a surplus use number for that user (S6). A surplus use number is a use number which is managed by the network manager only, and hence the numerical value thereof is not reported to the user. If the charge management server judges that there is a surplus use number, then it transfers to the processing in S4. Moreover, if it judges that there is no surplus use number, then the charge management server announces termination of the connection to the user (S7), and after a prescribed period of time has elapsed, the connection is terminated (S8). If the use number reported to the user is used up and deduction processing is performed with respect to the surplus use number, it is also possible for a notice to this effect (that the user has entered overtime use) to be conveyed to the client.

In this way, according to the present embodiment, when a user has logged in to a network server, then even if the use number for that user has reached zero, rather than terminating the connection straight away, a certain connection time is provided additionally to the user, before the connection is terminated.

Therefore, by prolonging a connection for time corresponding to a surplus use number, when the use number for a user has become zero, it is possible at least to protect services that are in use at the time that the use number becomes zero. This means that the stress caused to the user can be alleviated, even in cases where a fault occurs during a network connection through no responsibility of the user.

In this embodiment, it is assumed that the use number is reduced towards a value of zero, but the embodiment is not limited to this (this applies similarly to the following embodiments).

### Sixth Embodiment

This embodiment is a charge management server wherein a game device of a user receives network connection services according to a use number, characterized in that even if the use number has become zero, the network connection services are not terminated immediately, until a previously specified date and time has passed.

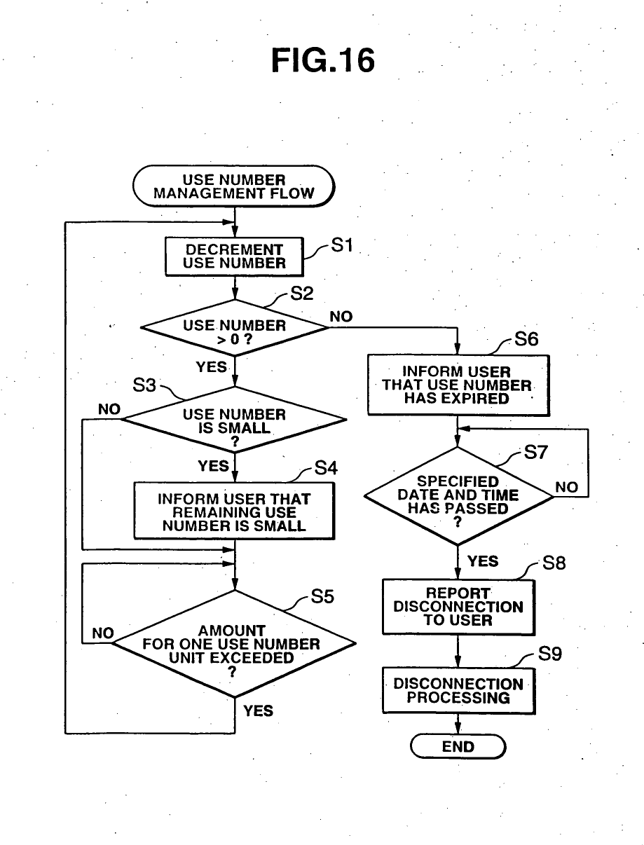

FIG. 16 is a flowchart for describing charge management processing in a network connection service relating to the present embodiment. In this diagram, when a user logs in to a server providing a network service, the use number for that user is reduced by one (S1). The charge management server then judges whether or not the use number for the user is greater than zero (S2), and if it judges the use number to be greater than zero, it proceeds to determine whether or not the remaining use number is small (S3). If the charge management server judges that the remaining use number is small, then it conveys a notice to this effect to the user (S4). The charge management server determines whether or not the time allocated to one use number unit has elapsed (S5), and if it judges that this time period has elapsed, then it returns to S1 and decrements the use number.

On the other hand, if at step S2 it is judged that the use number is zero or less, then the charge management server sends a notice indicating that the use number has reached zero to the user (S6), and the charge management server then permits connection as long as the user does not log off from the network. During the connection, the charge management server checks whether or not the specified date and time has passed (S7), and if it judges that this specified date and time has passed, then it reports termination of the connection to the user (S8) and after a prescribed time period has elapsed, it terminates the connection (S9). The specified date and time is, for example, set to zero hours in the morning of the day following the day that the user logged in.

In this way, according to this embodiment, it is possible to protect a connection for a user to a certain extent, even in cases where the use number has become zero.

### Seventh Embodiment

This embodiment is a modification of the sixth embodiment and is characterized in that the excess use number until passing of the specified date and time is used to make an adjustment, the next time that a connection is made.

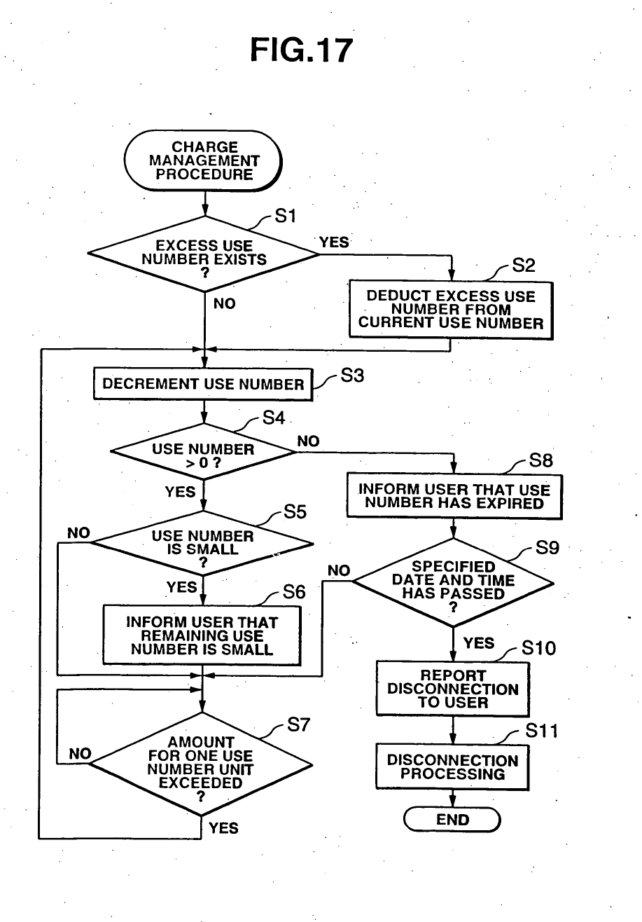

FIG. 17 is a flowchart for describing charge management processing in a network connection service relating to the present embodiment. In this diagram, when a user logs in to a server providing a network service, the charge management server determines whether or not that user has a use number that was exceeded during the previous connection (S1). If it is judged that the user does have a use number that was exceeded during the previous connection, the charge management server makes an adjustment by subtracting the excess use number from the current use number for the user (S2). Thereupon, with respect to the current usage, the charge management server further decrements the use number for the user by one unit (S3). The charge management server judges whether or not the use number for the user is greater than zero (S4), and if it judges that the use number is greater than zero, it further determines whether or not the remaining use number is small (S5). If the charge management server judges that the remaining use number is small, it conveys a notice to this effect to the user (S6). The charge management server then judges whether or not the time period allocated to one use number unit has elapsed (S7), and if it judges that this time period has elapsed, it returns to S3 and decrements the use number.

On the other hand, if it is judged at step S4 that the use number is zero or below, then the charge management server notifies the user that the use number has reached zero (S8), and it then judges whether or not the specified date and time has elapsed (S9). If it judges that the specified date and time has not elapsed, then it moves to S7 in order to aggregate the use number that is to be used for adjustment at the next log-in. If, on the other hand, it judges that the specified date and time has elapsed, then termination of connection is announced to the user (S10), and after a prescribed period of time has passed, the connection is terminated (S11).

As described above, according to the present embodiment, it is possible to protect a connection for a user to a certain extent, even if the use number has reached zero. Moreover, according to this embodiment, it is possible to perform an adjustment with respect to the exceeded use number, at the next time that the user logs in.

### Eighth Embodiment

This embodiment relates to a charge management server whereby the game device of a user (client device) is provided with network connection services according to a use number, characterized in that time-specific charging for reducing the use number value with respect to the connection time is implemented whilst the user is playing a network game, or the like, and relative value charging corresponding to a content is implemented when downloading a content. Relative value charging is carried out, for example, by subtracting a use number value corresponding to the content from the current use number value. In other words, the present embodiment is characterized in that during downloading, a separate charge is applied with respect to a relative value allocated to each respective content, rather than implementing charging with respect to the connection time. Thereby, it is possible to prevent variations in the charge (use number) depending on the speed of the communications circuit.

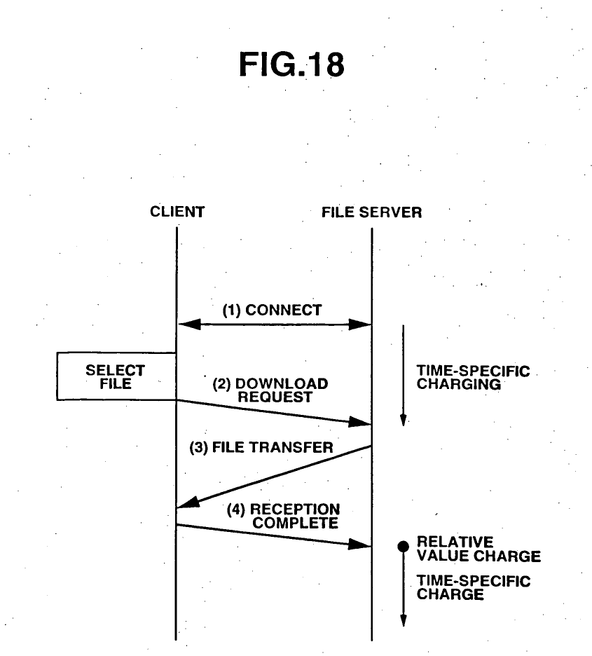

More specifically, FIG. 18 is a sequence for describing charge management processing relating to the present embodiment. In this diagram, firstly, a client 1 operated by the user connects to a file server 2, and a content purchase screen is displayed, for example ((1) in the diagram. In this state, the file server 2 (charge management server 2b) implements charging (specific charging) corresponding to the connection time, by means of use number management processing as described in any one of the fifth to seventh embodiments above. By means of the user selecting a desired file at the contents purchase screen, the client 1 sends a download request to the file server 2 ((2)). Upon receiving this download request, the file server 2 temporarily halts the specific charge processing, and implements transfer of the file specified in the download request ((3)). If the client 1 has received the file correctly, it sends a file reception complete message to the file server 2 ((4)). This file transfer processing may be performed according to the mode described in either the first or second embodiment above. Having receiving a file reception complete message, the file server 2 implements charge processing for a use number previously determined with respect to the file (content) downloaded by the user in this operation, whereupon it transfers to specific charging.

In order to switch between a mode where specific charging is applied and a mode where relative value charging is applied, the file server 2 is composed in such a fashion that it monitors whether or not a download request has been received, and if a download request has been received, it implements relative value charge processing by means of an interrupt to the specific charge processing. Moreover, the charge processing applied to the download operation may also be devised in such a manner that, rather than subtracting a previously determined use number value corresponding to the content from the current use number, the relative value is charged separately by means of a different electronic currency, or the like.

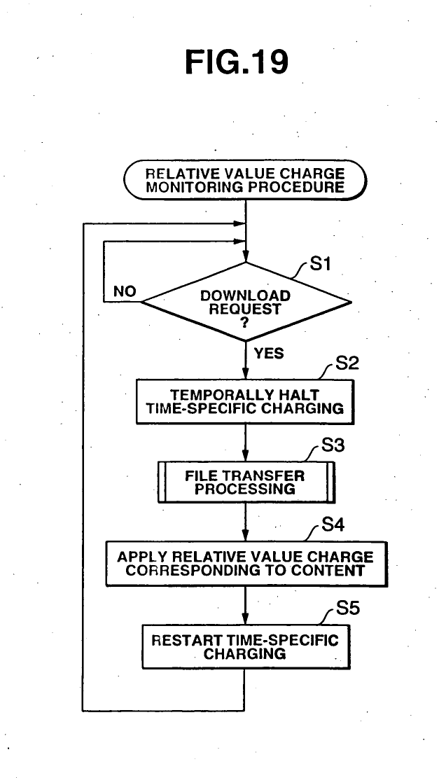

More specifically, FIG. 19 is a flowchart for describing relative charge processing. As shown in the diagram, the file server 2 monitors whether or not a download request has been received (S1). In this state, the file server 2 performs use number management processing (FIG. 15 to FIG. 17) as described in any one of the fifth to seventh embodiments above. Upon receiving a download request from the client 1, the file server 2 temporarily suspends the current use number management processing (S2), and performs file transfer processing (S3). When the file server 2 then receives a reception complete message indicating that the download has been performed correctly in file transfer processing, it implements relative value charging corresponding to the file (S4). The file server 2 then restarts the temporarily suspended specific charge processing (S5).

Thereby, since the file server 2 applies relative value charging corresponding to the transferred file, at the point in time that the file transfer is completed, rather than applying specific charging during file transfer, it is possible to eliminate problems whereby the cost (use number) varies according to the state of the communications circuit.

### Advantages of the Foregoing Embodiments

According to embodiments described above, even in cases where the size of a content file is simply very large, or where there is line congestion through no fault of the user, or the like, although the user is obliged to be connected for a long period of time, a corresponding use fee is not charged to the user.

Moreover, according to embodiments described above, some surplus margin is allowed in the connection use number without being reported to the user, and therefore even if a fee expires during a network connection, the connection can be maintained for period corresponding to the surplus margin. Thereby, the user is not subjected to stress relating to sudden circuit disconnection caused by expiry of a use fee.

Moreover, according to embodiments described above, even in cases where a plurality of download operations are performed by a plurality of users sharing a single terminal, it is possible to implement charging with respect to the download operations. Therefore, the service provider is able substantially to collect profits which are not conventionally collectable.

Furthermore, according to embodiments described above, no charging is applied in respect of periods where the service is unusable through no responsibility of the user, due to server maintenance, or the like.

Moreover, according to embodiments described above, charging is only implemented in cases where the client has received a file correctly, thereby eliminating problems whereby charging is applied even in the case of communication faults, or the like, which are not the responsibility of the user.

### Ninth Embodiment

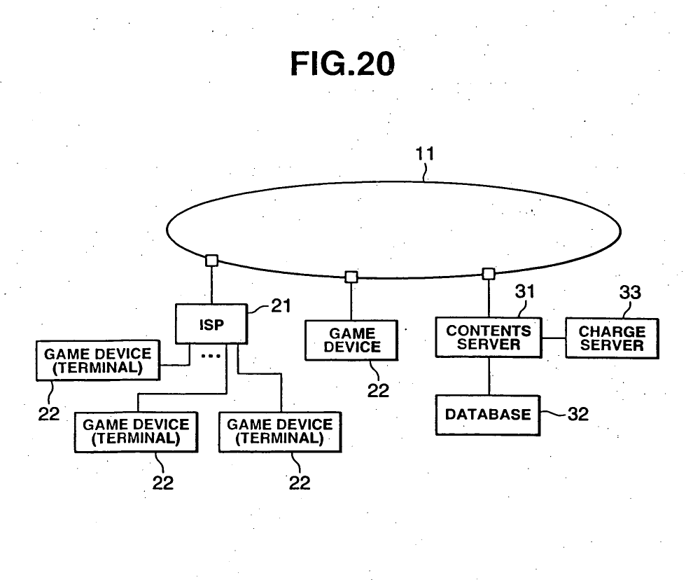

A further embodiment of the present invention is described here with reference to the drawings. FIG. 20 is a diagram giving an approximate illustration of a system composition to which the present invention is applied, wherein network terminal devices (or information processing devices) 22 located at a plurality of client devices, and various servers, are connected to the Internet (communications network) 1. The terminal devices 22 include devices connected directly to the Internet, and devices connected to the Internet by means of a connection service provider (ISP) 21. The terminal devices 22 are computer systems provided with a communications function, and they also include game devices provided with a communications function. The terminal devices 22 are provided with a keyboard for inputting data and commands, a CPU for implementing data processing, a communications interface device for communicating with the Internet or public communication networks, or satellite broadcast, satellite communications, or the like, an image processing device for performing image data processing, a display control device for performing monitor display control, an MPEG reproduction device for decoding MPEG data, a video monitor for displaying images and reproducing sound in stereo, a game controller for performing game operations, a memory card for storing data, a storage device, such as a hard disk, or the like, a CD-ROM drive, and the like, these respective elements not being illustrated in the diagram. In many cases, a game device is not provided with a large-capacity storage device, such as a hard disk, but since it comprises a high-performance image processing device for MPEG reproduction, and the like, it is suitable for reproduction of streaming data, such as video programs, or the like.

A contents server (file server) 31 is connected to the Internet 1. This contents server 31 holds a plurality of digitised program information (program data), such as video images, still images, sounds, text, numerical values, and the like, in a large-capacity database device 32. As described hereinafter, in response to access by a user via the Internet, a corresponding program is read out from the database device 32 and sent to the user by means of the Internet. The transmitted data (program data) is streaming data in a so-called MPEG2, MP3 (MPEG1 Audio Layer 3) or WAVE format, or the like.

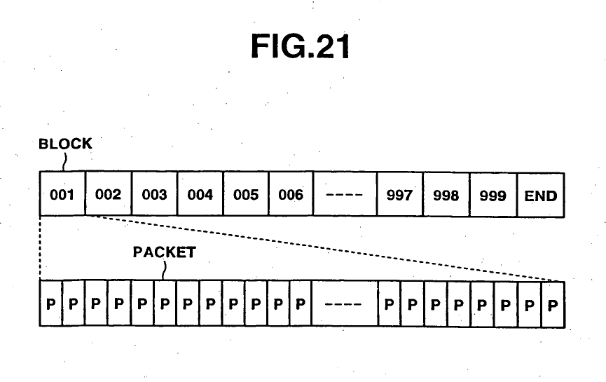

As illustrated in FIG. 21, this streaming data is previously formed into blocks according to charge units. Each block is formed by a series of packets P. Charging may involve a different fee for each program, or a different fee may be set for each block. For example, it is possible to vary the per block fee between interesting portions of the program and less interesting portions thereof. This information is held by a charge server 33 in the form of a program price list.

When the contents server 31 performs user authorization, it sends one sequence of the blocked program data in response to the request from the user. Each time that reception of the block sent to the user is confirmed, a charge instruction is sent to the charge server 33. The charge server 33 successively processes the charge instructions sent by the contents server 31, and it records the charge applied to each respective user in a previously created charge book.

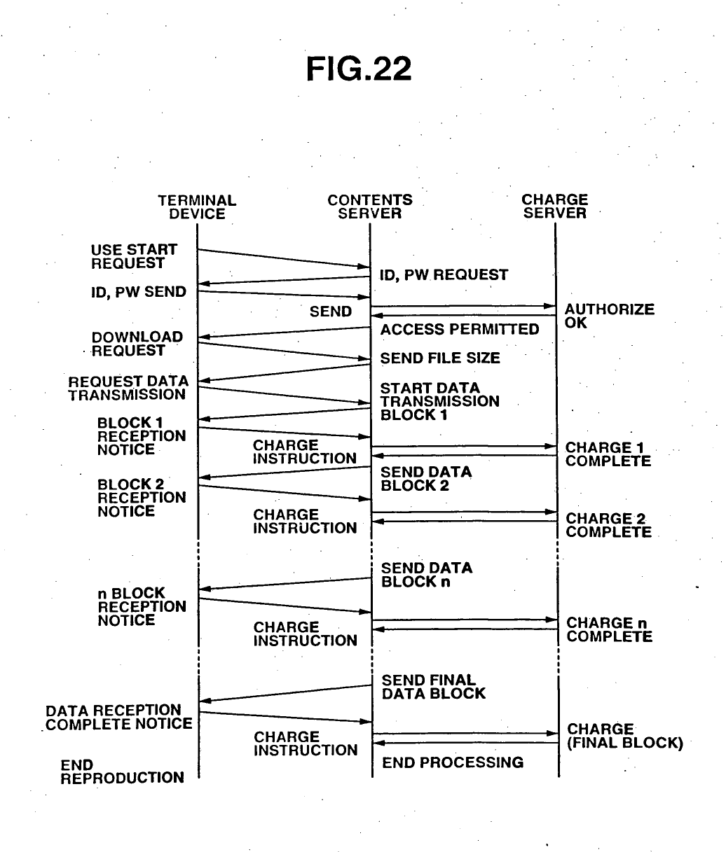

Next, the transmission and reception of streaming data between the terminal device and contents server will be described with reference to FIG. 22 to FIG. 24.

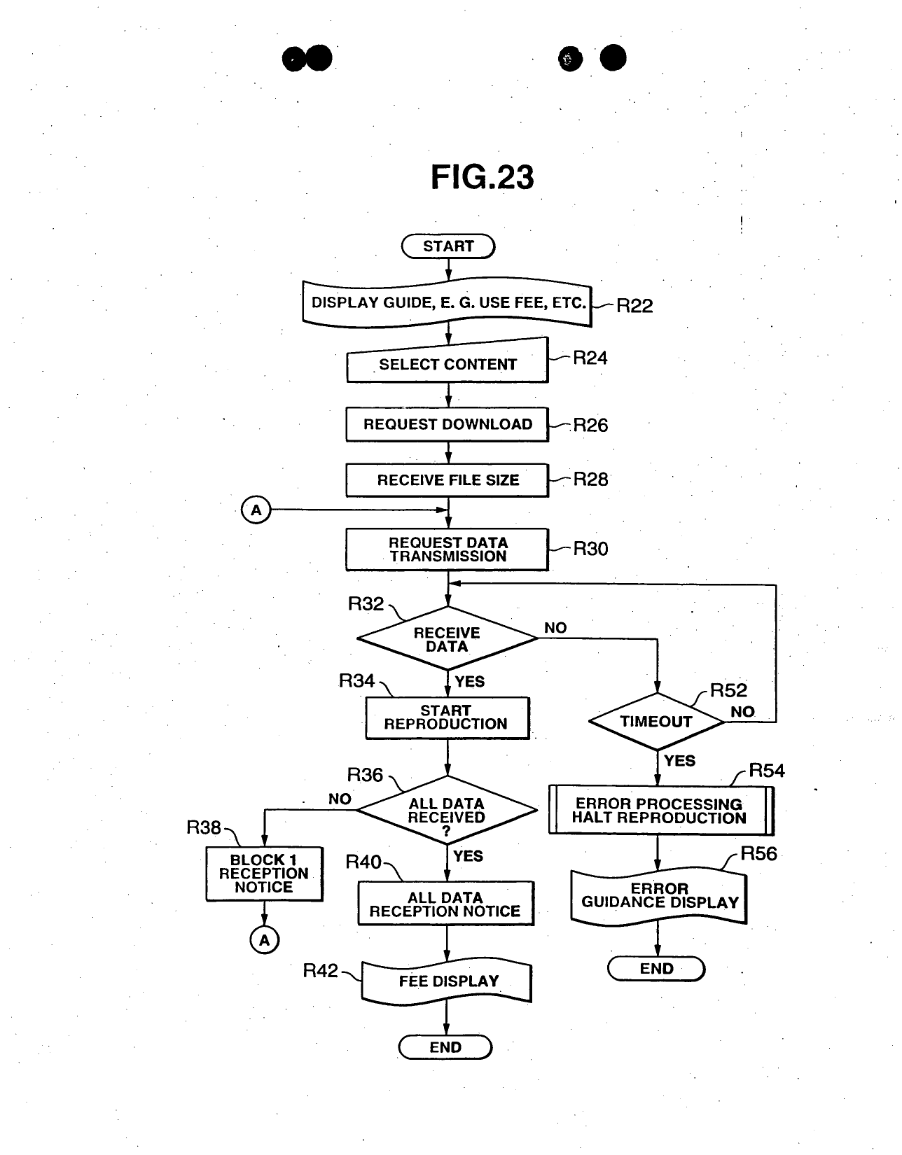

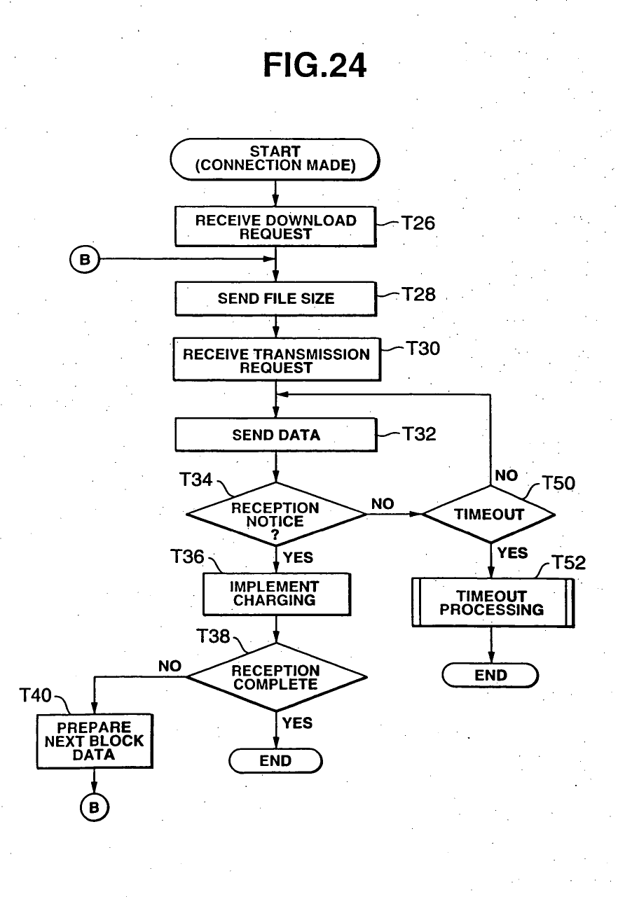

FIG. 22 is a communications diagram illustrating the communications states of a terminal device 22, contents server 31 and charge server 33, in a time series fashion. FIG. 23 is a flowchart illustrating the operation of a terminal device. FIG. 24 is a flowchart illustrating the operation of the contents server 31.

Firstly, a user connects the terminal device 22 to the Internet 1 and accesses the home page of the contents server 31. When the user makes a use start request at the home page, the contents server 31 requests input of an identification number (ID) and password (PW). When the user has input a previously assigned identification number and password, the contents server 31 compares same with the identification numbers and passwords for users listed in the charge book of the charge server 33. If there is a match with the identification number and password, then access is permitted (authorization). The contents server 31 sends a guide of programs and use fees to the terminal device 22, and this guide is displayed on the screen (not illustrated) of the terminal device 22 (R22). The user selects a desired program (content) from the guide showing programs, use fees, and the like, displayed on the screen of the terminal device 22 (R24). The selected program is transmitted as the contents server 31 in the form of a download request for that program (R26). Upon receiving this download request, the contents server 31 reads out the file size of the corresponding program from a database and sends this information to the terminal device 22 (T28). This file size is displayed on the screen of the terminal device 22, and it is used to calculate and display a broadcast time, as well as subsequently being used as a reference in reception of the final data block, and the like.

When the user requests provision of the program, by operating the keyboard, selecting an icon, or the like, a data transmission request is sent from the terminal device 22 to the contents server 31 (R36). Upon receiving this transmission request (T30), the contents server 31 reads out the corresponding program from the database to a buffer memory, and then sends the first block thereof to the terminal device 22 (T32). When the terminal device 22 receives the first block of the program data, in a transmitting and receiving section which is not illustrated in the drawings, (R32; YES), this data is transferred to the internal MPEG decoder, or the like, and streaming reproduction of the program is started (R34). The video/audio signal reproduced by the decoder is sent to a video monitor (not illustrated), where the program is reproduced by video images and sounds. It is then determined whether or not reception of all of the data (all blocks) has been completed (R36).

As stated above, completion of reproduction can be detected by comparing the file size (or total number of blocks) with the hitherto received data volume (or number of blocks). In the case of MPEG format data, this can be detected by identifying the presence or absence of a code indicating the final data element. Since the final block has not yet been reached (R36: NO), it is reported to the contents server 31 that one block has been received (R38).

If the contents server 31 does not receive a first block reception notice from the terminal device 22 (T34: NO), then the block is retransmitted (T32). If the contents server 31 does receive a first block reception notice (T34: YES), then it reports reception of the first block transmission to the charge server 33 and instructs same to apply a charge corresponding to that block. The charge server 33 records the charge for that block in the charge book (T36). Thereupon, it is determined whether or not a reception notice has been received for all data (T38). At this stage, reception of all data has not yet been reported (T38: NO), and hence the contents server 31 prepares to transmit the next block (T40).

The terminal device 22 repeats the operations of data reception (R32), data reproduction (R34), second block reception notification (R38) and data transmission request (R30), in a similar manner. The contents server 31, on the other hand, repeats the operations of receiving a data transmission request (T30), transmitting data of the next block (T32), receiving a reception notice (T34), implementing charge processing (T36) and preparing for transmission of the next data block (40), in a similar manner.

By repeating transmission and reception of block data in this way, the blocks are transmitted in a continuous fashion from the server 31 to the terminal device 22.

When the terminal device 22 receives the final block (R36; Yes), it outputs a reception complete notice informing the contents server 31 that all data has been received completely (R40), displays a charge on the screen of the terminal device 22 (R42), and then terminates playback of the content. The contents server 31, on the other hand, upon receiving the reception complete notice (T34; YES), implements charging (T36), and then terminates content transmission in response to the completion of reception (T38; YES).

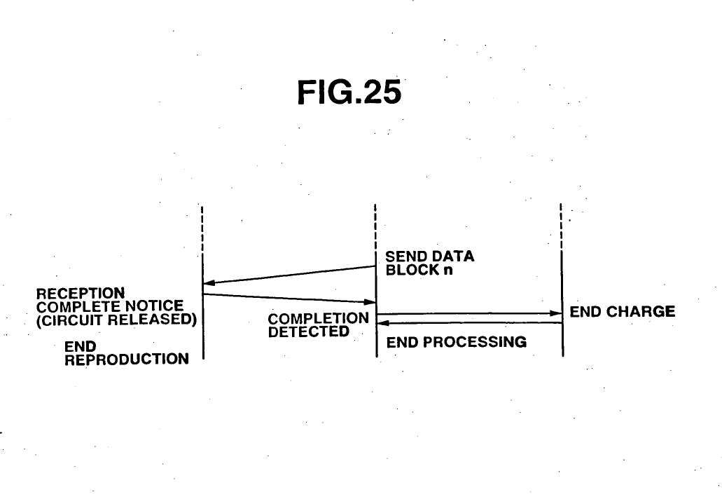

FIG. 25 is a communications diagram illustrating a state where transmission of block data is terminated at an intermediate stage. If the user gives a halt reproduction (halt reception) command at the terminal device 22 during reproduction of a program, by operating the keyboard or an icon on the screen, for instance, then a reception termination notice is transmitted to the contents server 31. Thereby, similarly to the case of reception completion, the contents server 31 implements charging (T36) and terminates content transmission in response to the termination of reception (T38; YES).

Next, error processing is described. If the terminal device 22 still has not received block data after a prescribed period of time has elapsed since making a data transmission request (R30), a time-out is performed (R52), and error processing is carried out. In error processing, the retransmission of block data is suspended (R54). A message indicating that an error has occurred is displayed on the screen of the display device (R58), and the terminal device 22 then reverts to a standby state.

Furthermore, if the contents server 31 does not receive a reception notice from the terminal device 22 (T34: NO) after transmitting data (T32) due to circuit disconnection, or the like, and a prescribed time period has elapsed (T50: YES), or if it has retransmitted a block a prescribed number of times and not received a reception notice, then the contents server 31 judges an error state and implements time-out processing, whereby content transmission to the terminal device 22 is terminated (T52). Thereupon, it reverts to a standby state.

The contents server 31, database 32 and charge server 33 described above can be constituted by the file server 2 illustrated in FIG. 2. The file server comprises first storage means (corresponding to the charge server 33) for storing use number data corresponding to the use numbers for the users, second storage means (corresponding to the database 32) for previously storing a plurality of program data for provision to users, respectively, in the form of blocks, and authorization means (corresponding to the contents server 31 and charge server 33) for performing authorization to permit or deny connection on the basis of individual user information sent by the information processing device operated by the user. The file server receives program data transmission requests sent by an information processing device (terminal device 22) that has received authorization, reads out specific program data as designated by the program data transmission request, from the second storage means, and transmits same in a sequential fashion to the information processing device. The file server also receives a confirmation message sent by the information processing device when reception of each block of the program data has been completed, and hence judges whether or not the transmission and reception of each block of the program data has been successful. If it judges that the transmission of the program data has been successful, then it updates the use number data for the user as stored in the first storage means, either respectively or collectively. As a result, specific charging corresponding to the data volume actually received by the user is implemented.

In this way, according to the foregoing embodiment of the present invention, charging which corresponds to the volume of streaming data transmitted from the contents server to the terminal device is implemented. Furthermore, even if the viewer halts the program at an intermediate stage, or if the circuit becomes disconnected, or the like, charging is still applied according to the volume of transmitted data, in respect of the block data that has been delivered or received.

In the foregoing embodiment, charge processing was performed after delivery of each respective block data was confirmed, but it is also possible to progressively store the number of blocks delivered, or the block numbers of delivered blocks, in the contents server, and then to transmit this data to the charge server as charge information, when program delivery has terminated.

Moreover, in this embodiment, the content was delivered to the terminal device one block at a time, but if the memory capacity of the terminal device so permits, it is also possible to deliver a plurality of blocks to the terminal device, simultaneously.

Furthermore, rather than setting the charge units separately for each program, it is also possible to set different charges for each block within a single program. In this case, it is possible to apply price weighting to the prices of more interesting and less interesting portions of a video program, for example. In cases where game data is transmitted together with video images, it is also possible to set a higher price for block sections which contain game data. It is also possible to change price settings between one type of video images (video images+4-channel sound) and another (video images+mono sound).

Furthermore, in the aforementioned embodiment, a charge server for implementing charge management is provided separately, but provided that the data processing capacity of the contents server is sufficiently high, the charge server can be omitted and charge management can be carried out by the content server.

Moreover, in the aforementioned embodiment, streaming data is supplied by means of the Internet, but the invention is not limited to this. For example, it is also possible to use a communications network such as a dedicated circuit, public communications circuit, local area network, wireless LAN, or the like.

Furthermore, the present invention can also be applied to cases where the up-link and down-link media are physically different, for instance, a case where program transmission requests are made to a contents server by means of a telephone circuit, and streaming data is delivered by means of a communications satellite, broadcast satellite, or the like. As stated above, it is possible to use streaming data in a variety of formats, such as MPEG2, MP3, WAVE, or the like.

### Further Embodiments

The embodiments described above are examples for the purpose of explaining the present invention, and the present invention is not limited to these embodiments. The present invention may be implemented in a variety of different modes, provided that these do not deviate from the essence of the invention.

For example, the operations of the functional means above were described as sequential operations, but the invention is not particularly limited to this. It is also possible to change the processing sequence or to perform parallel operation, provided that there are no operational conflicts. Furthermore, it is also possible to combine embodiments, in an appropriate manner.

In the respective embodiments described above, the information processing device or client (device) connected to a server by means of the Internet or a communications circuit also encompasses network devices, network terminal devices, portable information processing device (PDA), personal computers, portable telephones, game devices, and the like, and substitution by one of these devices lies within the scope of the present invention.

According to the present invention, when an information processing device (or client device) operated by a user downloads a file, such as a program application, from a file server in order to play a game, it is possible to perform suitable charge management in respect of the game program or in respect of execution of the game, by managing the use number relating to that user.

Moreover, according to the charging method and device of the present invention, the server is notified each time a prescribed amount of content data is received by the terminal device, and hence charging can be implemented in accordance with the amount of data actually transmitted.

1-11. (canceled)

12. An information processing device comprising:
volatile storage means for storing data;
receiving means for receiving a program application from a file server and outputting said received program application to said storage means;
executing means for executing said program application; and
halting means for halting the execution of said program application as executed by said executing means, on the basis of prescribed management information.

13. An information processing device comprising:
volatile storage means for storing data;
receiving means for receiving a program application from a file server and outputting said received program application to said storage means;
executing means for executing an emulator program in order to run said program application; and
halting means for halting the execution of said program application and/or said emulation program as executed by said executing means, on the basis of prescribed management information.

14. The information processing device according to claim 12 or claim 13, wherein said prescribed management information is either information relating to the use time period of said program application or information relating to the number of uses thereof of said program application.

15. The information processing device according to claim 12 or claim 13, wherein said information processing device erases said program application stored in said storing means, when said halting means halts execution of said program application and/or said emulation program.

16. The information processing device according to claim 12 or claim 13, wherein said information processing device further comprises means for receiving information relating to initial start-up from said file server; and said executing means executes said emulator program and/or said program application when said information relating to initial start-up is received.

17. The information processing device according to claim 12 or claim 13, wherein
said information processing device further comprises clock means for measuring time;
said prescribed management information is information relating to the use time period of said program application; and
said halting means halts execution of said program application and/or said emulator program on the basis of the time measured by said clock means and said use time period.

18. The information processing device according to claim 12 or claim 13, wherein said receiving means receives management information relating to the use time period of said program application from said file server.

19. An information processing device comprising:
volatile storage means for storing data;
clock means for measuring time;
first receiving means for receiving management information relating to a use time period from a file server;
judging means for judging whether or not a program application transmission request can be made to said file server, on the basis of the time period measured by said clock means and said received management information relating to the use time period;
second receiving means for making a transmission request for said program application to said file server, when it is judged that said transmission request can be made, receiving a program application sent from said file server in response to said transmission request, and outputting said received program application to said storage means; and
executing means for executing an emulator program in order to execute said received program application.

20. The information processing device according to claim 19, wherein said information processing device further comprises halting means for controlling said executing means so as to halt execution of said program application and/or said emulator program, on the basis the time period measured by said clock means and a time period indicated by management information relating to said use time period.

21. The information processing device according to claim 20, wherein said halting means performs control in such a manner that execution of said program application and/or said emulator program is halted if the time period measured by said clock means has exceeded a time period obtained by adding a prescribed time period to the time period indicated by the management information relating to said use time period.

22. The information processing device according to claim 19, wherein said judging means judges that said transmission request cannot be made, in cases where the time period measured by said clock means exceeds the time period indicated by the management information relating to said use time period.

23. The information processing device according to claim 13 or claim 19, wherein said emulator program is read in from an external storage medium.

24-32. (canceled)

33. A method for controlling an information processing device comprising the steps of:
receiving a program application from a file server;
storing said received program application in volatile storing means;
executing an emulator program in order to execute said program application; and
halting the execution of said program application on the basis of management information relating to a use time period.

34-62. (canceled)
